(19) United States
(12) Patent Application Publication
(10) Pub. No.: US 2022/0212690 A1
(43) Pub. Date: Jul. 7, 2022

(54) VEHICLE-MOUNTED DEVICE INFORMATION DISPLAY METHOD, APPARATUS, AND VEHICLE

(71) Applicant: HUAWEI TECHNOLOGIES CO., LTD., SHENZHEN (CN)

(72) Inventors: Weixi ZHENG, Shenzhen (CN); Guanhua WANG, Xi'an (CN); Zijie CHEN, Hangzhou (CN); Xueyan HUANG, Shenzhen (CN)

(21) Appl. No.: 17/703,053

(22) Filed: Mar. 24, 2022

Related U.S. Application Data
(63) Continuation of application No. PCT/CN2020/110506, filed on Aug. 21, 2020.

(30) Foreign Application Priority Data
Sep. 25, 2019 (CN) 201910912412.5

(51) Int. Cl. B60W 50/14; B60K 35/00

(52) U.S. Cl. CPC B60W 50/14; B60W 2555/60; B60W 2050/146; B60W 2552/53; B60K 2370/31; B60W 2556/65; B60K 2370/178; B60W 2554/4041; B60W 2552/35; B60W 2555/20; B60K 2370/166; B60W 2552/10; B60W 2554/802; B60K 2370/179; B60K 2370/27; B60W 2554/406; B60W 2554/4042; B60W 2552/05; B60K 35/00

(57) ABSTRACT

A vehicle-mounted device information display method is provided. The method is applied to the Internet of Vehicles or self-driving field and includes: obtaining information about lane lines of a road surface on which a first vehicle is located, where the lane lines are at least two lines on the road surface that are used to divide different lanes; and displaying, based on the information about the lane lines, virtual lane lines whose types are consistent with those of the lane lines. This method can be applied to a self-driving interface in an intelligent car, so that a driver can obtain, from the self-driving interface, types of the lane lines of the traveling road surface in this case. This enriches display content of the self-driving interface.

### CROSS-REFERENCE TO RELATED APPLICATIONS

This application is a continuation of International Application No. PCT/CN2020/110506, filed on Aug. 21, 2020, which claims priority to Chinese Patent Application No. 201910912412.5, filed on Sep. 25, 2019. The disclosures of the aforementioned applications are hereby incorporated by reference in their entireties.

### TECHNICAL FIELD

This application relates to the intelligent vehicle or self-driving field, and in particular, to a vehicle-mounted device information display method, an apparatus, and a vehicle.

### BACKGROUND

A self-driving technology relies on cooperation of artificial intelligence, visual computing, radar, a monitoring apparatus, and a global positioning system, so that a motor vehicle can implement self-driving without an active manual operation. Because the self-driving technology does not require a human to drive a motor vehicle, can theoretically avoid human driving mistakes effectively, reduce traffic accidents, and improve road transportation efficiency, the self-driving technology attracts increasing attention.

During self-driving, a vehicle-mounted device inside a vehicle may display a self-driving interface. A lane in which the vehicle is located and other vehicles located near the vehicle may be displayed on the self-driving interface. However, as a road surface environment becomes increasingly complex, display content of an existing self-driving interface cannot satisfy requirements of a driver.

### SUMMARY

Embodiments of this application provide a vehicle-mounted device information display method, an apparatus, and a vehicle, to enrich display content of a self-driving interface.

According to a first aspect, this application provides a vehicle-mounted device information display method, including: obtaining information about lane lines of a road surface on which a first vehicle is located, where the lane lines are at least two lines on the road surface that are used to divide different lanes; and displaying, based on the information about the lane lines, virtual lane lines whose types are consistent with those of the lane lines.

In an embodiment of this application, the virtual lane lines consistent with the lane lines corresponding to the obtained information about the lane lines are displayed on a self-driving interface, so that a driver can see, from the self-driving interface, the virtual lane lines corresponding to the types of the actual lane lines of the traveling road surface in this case. This not only enriches display content of the self-driving interface, but also improves driving safety.

It should be noted that “consistent” herein does not emphasize that the virtual lane lines are exactly the same as the lane lines of the road surface, and there may always be some differences between the virtual lane lines displayed by using a computer screen and the actual lane lines. This application is intended to indicate an actual lane to the driver for reference. The lane lines indicated in an indication manner are close to the actual lane lines as much as possible. However, presented effects of the lines may be different from those of the actual lane lines in terms of a color, a shape, a material, and the like. Further, other indication information may be displayed in addition to the virtual lane lines.

In an embodiment, the obtaining information about lane lines of a road surface on which a first vehicle is located includes: obtaining information about lane lines of a lane in which the first vehicle is located.

In an embodiment, the lane lines include at least one of the following lane lines: a dashed line, a solid line, a double dashed line, a double solid line, and a dashed solid line. It should be noted that types of the virtual lane lines displayed on the self-driving interface may be consistent with those of the actual lane lines, for example, shapes thereof are consistent.

In an embodiment, the lane lines include at least one of the following lane lines: a dashed white line, a solid white line, a dashed yellow line, a solid yellow line, a double dashed white line, a double solid yellow line, a dashed solid yellow line, and a double solid white line. It should be noted that shapes and colors of the virtual lane lines displayed on the self-driving interface may be consistent with those of the actual lane lines.

In an embodiment, the method further includes: obtaining information about a non-motor vehicle object on the road surface; and displaying, based on the information about the non-motor vehicle object, an identifier corresponding to the non-motor vehicle object.

In an embodiment, the method further includes:

receiving a sharing instruction, where the sharing instruction carries an address of a second vehicle; and

sending second shared information to the second vehicle in response to the sharing instruction, where the second shared information includes location information of the non-motor vehicle object.

In an embodiment, the method further includes:

receiving first shared information sent by a server or the second vehicle, where the first shared information includes the location information of the non-motor vehicle object; and

displaying an obstacle prompt on a navigation interface when the first vehicle enables navigation, where the obstacle prompt is used to indicate the non-motor vehicle object at a location corresponding to the location information.

In an embodiment, the non-motor vehicle object includes at least a road depression, an obstacle, and a road water accumulation.

In an embodiment, the method further includes:

displaying a lane change indication when the non-motor vehicle object is located on a navigation path indicated by a navigation indication, where the navigation indication is used to indicate the navigation path of the first vehicle, and the lane change indication is used to instruct the first vehicle to avoid a traveling path of the non-motor vehicle object.

In an embodiment, the method further includes:

displaying a first alarm prompt when a distance between the first vehicle and the non-motor vehicle object is a first distance; and

displaying a second alarm prompt when the distance between the first vehicle and the non-motor vehicle object is a second distance, where the second alarm prompt is different from the first alarm prompt.

In an embodiment, a color or transparency of the first alarm prompt is different from that of the second alarm prompt.

In an embodiment, the method further includes:

obtaining navigation information of the first vehicle; and

displaying the navigation indication based on the navigation information, where the navigation indication is used to indicate the navigation path of the first vehicle.

In an embodiment, the navigation indication includes a first navigation indication or a second navigation indication, and the displaying the navigation indication based on the navigation information includes:

displaying the first navigation indication based on a stationary state of the first vehicle; and

displaying the second navigation indication based on a traveling state of the first vehicle, where the first navigation indication is different from the second navigation indication.

In an embodiment, a display color or display transparency of the first navigation indication is different from that of the second navigation indication.

In this embodiment of this application, different navigation indications are displayed based on traveling statuses of the first vehicle, so that the driver or a passenger can determine a current traveling status of the vehicle based on display of the navigation indication on the navigation interface.

In an embodiment, the navigation indication includes a third navigation indication or a fourth navigation indication, and the displaying the navigation indication based on the navigation information includes:

displaying the third navigation indication based on a first environment of the first vehicle; and

displaying the fourth navigation indication based on a second environment of the first vehicle, where the first environment is different from the second environment, and the third navigation indication is different from the fourth navigation indication.

In an embodiment, the first environment includes at least one of the following environments: a weather environment in which the first vehicle is situated, a road surface environment in which the first vehicle is situated, a weather environment of a navigation destination of the first vehicle, a road surface environment of the navigation destination of the first vehicle, a traffic congestion environment of a road on which the first vehicle is located, a traffic congestion environment of the navigation destination of the first vehicle, or a brightness environment in which the first vehicle is situated.

In an embodiment of this application, the first vehicle may display a first lane based on the first environment of the first vehicle, and display a second lane based on the second environment of the first vehicle. The first lane and the second lane are lanes in which the first vehicle travels, or lanes of the road surface on which the first vehicle is located. The first environment is different from the second environment, and the first lane is different from the second lane. The driver or a passenger can obtain, based on display of an autonomous navigation interface, a current environment in which the vehicle is situated, especially at night or in other scenarios with relatively low brightness. This improves driving safety.

In an embodiment, the method further includes:

displaying a first area based on a straight-driving state of the first vehicle; and

displaying a second area based on a change of the first vehicle from the straight-driving state to a left-turning state, where a left-front scene area that is included in the second area and that is in a traveling direction of the first vehicle is greater than a left-front scene area included in the first area.

In an embodiment, the method further includes:

displaying a third area based on a left-turning state of the first vehicle; and

displaying a fourth area based on a change of the first vehicle from the left-turning state to a straight-driving state, where a right-rear scene area that is included in the third area and that is in a traveling direction of the first vehicle is greater than a right-rear scene area included in the fourth area.

In an embodiment, the method further includes:

displaying a fifth area based on a straight-driving state of the first vehicle; and

displaying a sixth area based on a change of the first vehicle from the straight-driving state to a right-turning state, where a right-front scene area that is included in the fifth area and that is in a traveling direction of the first vehicle is less than a right-front scene area included in the sixth area.

In an embodiment, the method further includes:

displaying a seventh area based on a right-turning state of the first vehicle; and

displaying an eighth area based on a change of the first vehicle from the right-turning state to a straight-driving state, where a left-rear scene area that is included in the seventh area and that is in a traveling direction of the first vehicle is greater than a left-rear scene area included in the eighth area.

In an embodiment of this application, when the first vehicle changes from a turning state to a straight-driving state, or when the first vehicle changes from a straight-driving state to a turning state, the first vehicle may change a current display field of view, so that the driver can know information about an area that may have a safety risk when the vehicle turns. This improves driving safety.

In an embodiment, the method further includes:

displaying a ninth area based on a first traveling speed of the first vehicle; and

displaying a tenth area based on a second traveling speed of the first vehicle, where the ninth area and the tenth area are scene areas in which a traveling location of the first vehicle is located, the second traveling speed is higher than the first traveling speed, and a scene area included in the ninth area is less than a scene area included in the tenth area.

In an embodiment of this application, the first vehicle may display the ninth area based on the first traveling speed of the first vehicle, and display the tenth area based on the second traveling speed of the first vehicle, where the ninth area and the tenth area are the scene areas in which the traveling location of the first vehicle is located, the second traveling speed is higher than the first traveling speed, and the scene area included in the ninth area is greater than the scene area included in the tenth area. In the foregoing manner, when the traveling speed of the first vehicle is relatively high, a larger scene area may be displayed, so that the driver can know more road surface information when the traveling speed is relatively high. This improves driving safety.

In an embodiment, the method further includes:

obtaining a geographical location of the navigation destination of the first vehicle; and

displaying a first image based on the geographical location, where the first image is used to indicate a type of the geographical location of the navigation destination of the first vehicle.

In an embodiment, the method further includes:

detecting a third vehicle;

obtaining a geographical location of a navigation destination of the third vehicle; and

displaying a second image based on the geographical location of the navigation destination of the third vehicle, where the second image is used to indicate a type of the geographical location of the navigation destination of the third vehicle.

In an embodiment, the type of the geographical location includes at least one of the following: city, mountain area, plain, forest, or seaside.

In an embodiment of this application, the first vehicle may obtain the geographical location of the navigation destination of the first vehicle, and display the first image based on the geographical location, where the first image is used to indicate the type of the geographical location of the navigation destination of the first vehicle. The first vehicle may display a corresponding image on the self-driving interface based on a geographical location of a navigation destination, to enrich content of the self-driving interface.

In an embodiment, the method further includes:

detecting that the first vehicle travels to an intersection stop area and displaying a first intersection stop indication.

In an embodiment, the intersection stop indication includes a first intersection stop indication or a second intersection stop indication, and the detecting that the first vehicle travels to an intersection stop area and displaying an intersection stop indication includes:

displaying the first intersection stop indication when detecting that a vehicle head of the first vehicle does not exceed the intersection stop area; and

displaying the second intersection stop indication when detecting that the vehicle head of the first vehicle exceeds the intersection stop area, where the first intersection stop indication is different from the second intersection stop indication.

In an embodiment, the intersection stop indication includes a third intersection stop indication or a fourth intersection stop indication, and the detecting that the first vehicle travels to an intersection stop area and displaying an intersection stop indication includes:

displaying the third intersection stop indication when detecting that the first vehicle travels to the intersection stop area and that a traffic light corresponding to the intersection stop area is a red light or a yellow light; and

displaying the fourth intersection stop indication when detecting that the first vehicle travels to the intersection stop area and that a traffic light corresponding to the intersection stop area is a green light, where the third intersection stop indication is different from the fourth intersection stop indication.

In an embodiment, the method further includes:

detecting a fourth vehicle; and

displaying a vehicle alarm prompt when a distance between the fourth vehicle and the first vehicle is less than a preset distance.

In an embodiment, the vehicle alarm prompt includes a first vehicle alarm prompt or a second vehicle alarm prompt, and the displaying a vehicle alarm prompt when a distance between the fourth vehicle and the first vehicle is less than a preset distance includes:

displaying the first vehicle alarm prompt when the distance between the fourth vehicle and the first vehicle is the first distance; and

displaying the second vehicle alarm prompt when the distance between the fourth vehicle and the first vehicle is the second distance, where the first distance is different from the second distance, and the first vehicle alarm prompt is different from the second vehicle alarm prompt.

In an embodiment of this application, the first vehicle may display a vehicle alarm prompt on the self-driving interface based on a distance between a nearby vehicle and the current vehicle, so that the driver can know a collision risk between the first vehicle and the another vehicle by using the alarm prompt displayed on the self-driving interface.

In an embodiment, the method further includes:

detecting a fifth vehicle;

displaying, when the fifth vehicle is located on a lane line of a lane in front of the traveling direction of the first vehicle, a third image corresponding to the fifth vehicle; and

displaying, when the fifth vehicle travels to the lane in front of the traveling direction of the first vehicle, a fourth image corresponding to the fifth vehicle, where the third image is different from the fourth image.

According to a second aspect, this application provides a vehicle-mounted device information display apparatus, including:

an obtaining module, configured to obtain information about lane lines of a road surface on which a first vehicle is located, where the lane lines are at least two lines on the road surface that are used to divide different lanes; and

a display module, configured to display, based on the information about the lane lines, virtual lane lines whose types are consistent with those of the lane lines.

In an embodiment, the obtaining module is configured to:

obtaining information about lane lines of a lane in which the first vehicle is located.

In an embodiment, the lane lines include at least one of the following lane lines: a dashed line, a solid line, a double dashed line, a double solid line, and a dashed solid line.

In an embodiment, the lane lines include at least one of the following lane lines: a dashed white line, a solid white line, a dashed yellow line, a solid yellow line, a double dashed white line, a double solid yellow line, a dashed solid yellow line, and a double solid white line.

In an embodiment, the obtaining module is further configured to obtain information about a non-motor vehicle object on the road surface; and

the display module is further configured to display an identifier corresponding to the non-motor vehicle object.

In an embodiment, the apparatus further includes:

a receiving module, configured to receive a sharing instruction, where the sharing instruction carries an address of a second vehicle; and

a sending module, configured to send second shared information to the second vehicle in response to the sharing instruction, where the second shared information includes location information of the non-motor vehicle object.

In an embodiment, the receiving module is further configured to receive first shared information sent by a server or the second vehicle, where the first shared information includes the location information of the non-motor vehicle object; and

the display module is further configured to display an obstacle prompt on a navigation interface when the first vehicle enables navigation, where the obstacle prompt is used to indicate the non-motor vehicle object at a location corresponding to the location information.

In an embodiment, the non-motor vehicle object includes at least a road depression, an obstacle, and a road water accumulation.

Optionally, in an optional design of the second aspect, the display module is further configured to display a lane change indication when the non-motor vehicle object is located on a navigation path indicated by a navigation indication, where the navigation indication is used to indicate the navigation path of the first vehicle, and the lane change indication is used to instruct the first vehicle to avoid a traveling path of the non-motor vehicle object.

In an embodiment, the display module is further configured to: display a first alarm prompt when a distance between the first vehicle and the non-motor vehicle object is a first distance; and

display a second alarm prompt when the distance between the first vehicle and the non-motor vehicle object is a second distance, where the second alarm prompt is different from the first alarm prompt.

In an embodiment, a color or transparency of the first alarm prompt is different from that of the second alarm prompt.

In an embodiment, the obtaining module is further configured to obtain navigation information of the first vehicle; and

the display module is further configured to display the navigation indication based on the navigation information, where the navigation indication is used to indicate the navigation path of the first vehicle.

In an embodiment, the navigation indication includes a first navigation indication or a second navigation indication, and the display module is configured to: display the first navigation indication based on a stationary state of the first vehicle; and

display the second navigation indication based on a traveling state of the first vehicle, where the first navigation indication is different from the second navigation indication.

In an embodiment, a display color or display transparency of the first navigation indication is different from that of the second navigation indication.

In an embodiment, the navigation indication includes a third navigation indication or a fourth navigation indication, and the display module is configured to: display the third navigation indication based on a first environment of the first vehicle; and

display the fourth navigation indication based on a second environment of the first vehicle, where the first environment is different from the second environment, and the third navigation indication is different from the fourth navigation indication.

In an embodiment, the first environment includes at least one of the following environments: a weather environment in which the first vehicle is situated, a road surface environment in which the first vehicle is situated, a weather environment of a navigation destination of the first vehicle, a road surface environment of the navigation destination of the first vehicle, a traffic congestion environment of a road on which the first vehicle is located, a traffic congestion environment of the navigation destination of the first vehicle, or a brightness environment in which the first vehicle is situated.

In an embodiment, the display module is further configured to: display a first area based on a straight-driving state of the first vehicle; and

display a second area based on a change of the first vehicle from the straight-driving state to a left-turning state, where a left-front scene area that is included in the second area and that is in a traveling direction of the first vehicle is greater than a left-front scene area included in the first area.

In an embodiment, the display module is further configured to: display a third area based on a left-turning state of the first vehicle; and

display a fourth area based on a change of the first vehicle from the left-turning state to a straight-driving state, where a right-rear scene area that is included in the third area and that is in a traveling direction of the first vehicle is greater than a right-rear scene area included in the fourth area.

In an embodiment, the display module is further configured to: display a fifth area based on a straight-driving state of the first vehicle; and

display a sixth area based on a change of the first vehicle from the straight-driving state to a right-turning state, where a right-front scene area that is included in the fifth area and that is in a traveling direction of the first vehicle is less than a right-front scene area included in the sixth area.

In an embodiment, the display module is further configured to: display a seventh area based on a right-turning state of the first vehicle; and

display an eighth area based on a change of the first vehicle from the right-turning state to a straight-driving state, where a left-rear scene area that is included in the seventh area and that is in a traveling direction of the first vehicle is greater than a left-rear scene area included in the eighth area.

In an embodiment, the display module is further configured to: display a ninth area based on a first traveling speed of the first vehicle; and

display a tenth area based on a second traveling speed of the first vehicle, where the ninth area and the tenth area are scene areas in which a traveling location of the first vehicle is located, the second traveling speed is higher than the first traveling speed, and a scene area included in the ninth area is greater than a scene area included in the tenth area.

In an embodiment, the obtaining module is further configured to obtain a geographical location of the navigation destination of the first vehicle; and

the display module is further configured to display a first image based on the geographical location, where the first image is used to indicate a type of the geographical location of the navigation destination of the first vehicle.

In an embodiment, a detection module is configured to detect a third vehicle;

the obtaining module is further configured to obtain a geographical location of a navigation destination of the third vehicle; and

the display module is further configured to display a second image based on the geographical location of the navigation destination of the third vehicle, where the second image is used to indicate a type of the geographical location of the navigation destination of the third vehicle.

In an embodiment, the type of the geographical location includes at least one of the following: city, mountain area, plain, forest, or seaside.

In an embodiment, the detection module is further configured to detect that the first vehicle travels to an intersection stop area, and the display module is further configured to display a first intersection stop indication.

In an embodiment, the intersection stop indication includes a first intersection stop indication or a second intersection stop indication, and the display module is further configured to:

display the first intersection stop indication when the detection module detects that a vehicle head of the first vehicle does not exceed the intersection stop area; and

display the second intersection stop indication when the detection module detects that the vehicle head of the first vehicle exceeds the intersection stop area, where the first intersection stop indication is different from the second intersection stop indication.

In an embodiment, the intersection stop indication includes a third intersection stop indication or a fourth intersection stop indication, and the display module is further configured to:

display the third intersection stop indication when the detection module detects that the first vehicle travels to the intersection stop area and that a traffic light corresponding to the intersection stop area is a red light or a yellow light; and

display the fourth intersection stop indication when the detection module detects that the first vehicle travels to the intersection stop area and that a traffic light corresponding to the intersection stop area is a green light, where the third intersection stop indication is different from the fourth intersection stop indication.

In an embodiment, the detection module is further configured to detect a fourth vehicle; and

the display module is further configured to display a vehicle alarm prompt when a distance between the fourth vehicle and the first vehicle is less than a preset distance.

In an embodiment, the vehicle alarm prompt includes a first vehicle alarm prompt or a second vehicle alarm prompt, and the display module is further configured to: display the first vehicle alarm prompt when the distance between the fourth vehicle and the first vehicle is the first distance; and

display the second vehicle alarm prompt when the distance between the fourth vehicle and the first vehicle is the second distance, where the first distance is different from the second distance, and the first vehicle alarm prompt is different from the second vehicle alarm prompt.

In an embodiment, the detection module is further configured to detect a fifth vehicle; and

the display module is further configured to: display, when the fifth vehicle is located on a lane line of a lane in front of the traveling direction of the first vehicle, a third image corresponding to the fifth vehicle; and

display, when the fifth vehicle travels to the lane in front of the traveling direction of the first vehicle, a fourth image corresponding to the fifth vehicle, where the third image is different from the fourth image.

According to a third aspect, this application provides a vehicle, including a processor, a memory, and a display. The processor is configured to obtain and execute code in the memory to perform the method according to any one of the first aspect or the optional designs of the first aspect.

In an embodiment, the vehicle supports a driverless function.

According to a fourth aspect, this application provides a vehicle-mounted apparatus, including a processor and a memory. The processor is configured to obtain and execute code in the memory to perform the method according to any one of the first aspect or the optional designs of the first aspect.

According to a fifth aspect, this application provides a computer-readable storage medium. The computer-readable storage medium stores instructions. When the instructions are run on a computer, the computer is enabled to perform the method according to any one of the first aspect or the optional designs of the first aspect.

According to a sixth aspect, this application provides a computer program (or referred to as a computer program product). The computer program includes instructions. When the instructions are run on a computer, the computer is enabled to perform the method according to any one of the first aspect or the optional designs of the first aspect.

This application provides a vehicle-mounted device information display method. The method is applied to the Internet of Vehicles field and includes: obtaining information about lane lines of a road surface on which a first vehicle is located, where the lane lines are at least two lines on the road surface that are used to divide different lanes; and displaying, based on the information about the lane lines, virtual lane lines that are consistent with the lane lines. This application can be applied to a self-driving interface in an intelligent car, so that a driver can see, from the self-driving interface, types of the lane lines of the traveling road surface in this case. This not only enriches display content of the self-driving interface, but also improves driving safety.

### BRIEF DESCRIPTION OF DRAWINGS

FIG. 1 is a functional block diagram of a self-driving apparatus with a self-driving function according to an embodiment of this application;

FIG. 2 is a schematic diagram of a structure of a self-driving system according to an embodiment of this application;

FIG. 3a and FIG. 3b show an internal structure of a vehicle according to an embodiment of this application;

FIG. 4a is a schematic flowchart of a vehicle-mounted device information display method according to an embodiment of this application;

FIG. 4b is a schematic diagram of a self-driving interface according to an embodiment of this application;

FIG. 5a is a schematic diagram of a self-driving interface according to an embodiment of this application;

FIG. 5b is a schematic diagram of a self-driving interface according to an embodiment of this application;

FIG. 5c is a schematic diagram of a self-driving interface according to an embodiment of this application;

FIG. 5d is a schematic diagram of a self-driving interface according to an embodiment of this application;

FIG. 5e is a schematic diagram of a self-driving interface according to an embodiment of this application;

FIG. 5f is a schematic diagram of a self-driving interface according to an embodiment of this application;

FIG. 6a is a schematic diagram of a self-driving interface according to an embodiment of this application;

FIG. 6b is a schematic diagram of a self-driving interface according to an embodiment of this application;

FIG. 7a is a schematic diagram of a self-driving interface according to an embodiment of this application;

FIG. 7b is a schematic diagram of a self-driving interface according to an embodiment of this application;

FIG. 7c is a schematic diagram of a self-driving interface according to an embodiment of this application;

FIG. 8a is a schematic diagram of a self-driving interface according to an embodiment of this application;

FIG. 8b is a schematic diagram of a self-driving interface according to an embodiment of this application;

FIG. 8c is a schematic diagram of a self-driving interface according to an embodiment of this application;

FIG. 8d is a schematic diagram of a self-driving interface according to an embodiment of this application;

FIG. 8e is a schematic diagram of a self-driving interface according to an embodiment of this application;

FIG. 8f is a schematic diagram of a self-driving interface according to an embodiment of this application;

FIG. 9a is a schematic diagram of a self-driving interface according to an embodiment of this application;

FIG. 9b is a schematic diagram of a self-driving interface according to an embodiment of this application;

FIG. 9c is a schematic diagram of a self-driving interface according to an embodiment of this application;

FIG. 10 is a schematic diagram of a self-driving interface according to an embodiment of this application;

FIG. 11a is a schematic diagram of a self-driving interface according to an embodiment of this application;

FIG. 11b is a schematic diagram of a self-driving interface according to an embodiment of this application;

FIG. 11c is a schematic diagram of a self-driving interface according to an embodiment of this application;

FIG. 11d is a schematic diagram of a self-driving interface according to an embodiment of this application;

FIG. 11e is a schematic diagram of a self-driving interface according to an embodiment of this application;

FIG. 11f is a schematic diagram of a self-driving interface according to an embodiment of this application;

FIG. 11g is a schematic diagram of a self-driving interface according to an embodiment of this application;

FIG. 11h is a schematic diagram of a self-driving interface according to an embodiment of this application;

FIG. 12a to FIG. 12d are schematic diagrams of a self-driving interface according to an embodiment of this application;

FIG. 13a to FIG. 13c are schematic diagrams of a self-driving interface according to an embodiment of this application; and

FIG. 14 is a schematic diagram of a structure of a vehicle-mounted device information display apparatus according to an embodiment of this application.

### DESCRIPTION OF EMBODIMENTS

Embodiments of this application provide a vehicle-mounted device information display method, an apparatus, and a vehicle.

The following describes the embodiments of this application with reference to the accompanying drawings. A person of ordinary skill in the art can learn that, with technology development and emergence of a new scenario, the technical solutions provided in the embodiments of this application are also applicable to a similar technical problem.

In the specification, claims, and the accompanying drawings of this application, the terms “first”, “second”, and the like are intended to distinguish between similar objects but do not necessarily indicate a specific order or sequence. It should be understood that the terms used in such a way are interchangeable in proper circumstances, and this is merely a discrimination manner for describing objects having a same attribute in embodiments of this application. In addition, the terms “include”, “have”, and any other variations thereof are intended to cover the non-exclusive inclusion, so that a process, method, system, product, or device that includes a series of units is not limited to those units, but may include other units not expressly listed or inherent to such a process, method, product, or device.

A vehicle described in this application may be an internal combustion engine vehicle that uses an engine as a power source, a hybrid vehicle that uses an engine and an electric motor as a power source, an electric vehicle that uses an electric motor as a power source, or the like.

In the embodiments of this application, the vehicle may include a self-driving apparatus 100 with a self-driving function.

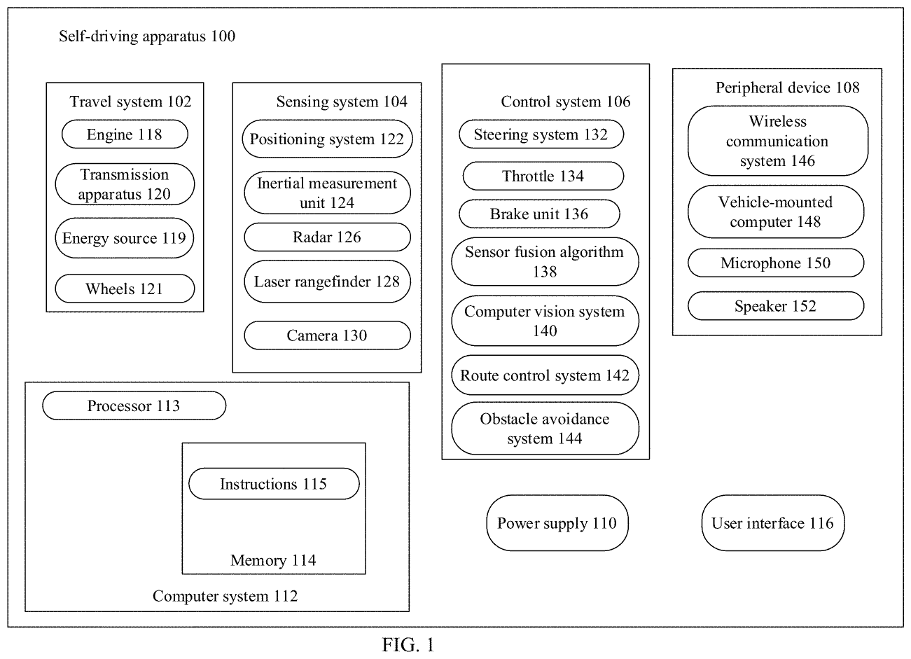

FIG. 1 is a functional block diagram of a self-driving apparatus 100 with a self-driving function according to an embodiment of this application. In an embodiment, the self-driving apparatus 100 is configured to be in a full or partial self-driving mode. For example, the self-driving apparatus 100 may control the self-driving apparatus 100 in the self-driving mode, determine the self-driving apparatus and a status of an ambient environment of the self-driving apparatus through a manual operation, determine possible behavior of at least one another vehicle in the ambient environment, determine a confidence level corresponding to a possibility of performing the possible behavior by the another vehicle, and control the self-driving apparatus 100 based on determined information. When the self-driving apparatus 100 is in the self-driving mode, it may be set that the self-driving apparatus 100 may operate in a case of not interacting with a person.

The self-driving apparatus 100 may include various subsystems, for example, a travel system 102, a sensor system 104, a control system 106, one or more peripheral devices 108, a power supply 110, a computer system 112, and a user interface 116. Optionally, the self-driving apparatus 100 may include more or fewer subsystems, and each subsystem may include a plurality of elements. In addition, the subsystems and the elements of the self-driving apparatus 100 may be all interconnected in a wired or wireless manner.

The travel system 102 may include components that power the self-driving apparatus 100. In an embodiment, the travel system 102 may include an engine 118, an energy source 119, a transmission apparatus 120, and wheels/tires 121. The engine 118 may be an internal combustion type engine, a motor, an air compression engine, or another type of engine combination, for example, a hybrid engine including a gasoline engine and a motor, or a hybrid engine including an internal combustion type engine and an air compression engine. The engine 118 converts the energy source 119 into mechanical energy.

Examples of the energy source 119 include gasoline, diesel, other oil-based fuels, propane, other compressed gas-based fuels, ethanol, solar panels, batteries, and other power sources. The energy source 119 may further provide energy for another system of the self-driving apparatus 100.

The transmission apparatus 120 may transmit mechanical power from the engine 118 to the wheels 121. The transmission apparatus 120 may include a gearbox, a differential, and a drive shaft. In an embodiment, the transmission apparatus 120 may further include another component, for example, a clutch. The drive shaft may include one or more shafts that may be coupled to one or more wheels 121.

The sensor system 104 may include several sensors that sense information about an ambient environment of the self-driving apparatus 100. For example, the sensor system 104 may include a positioning system 122 (the positioning system may be a global positioning system (GPS), or may be a Beidou system or another positioning system), an inertial measurement unit (inertial measurement unit, IMU) 124, radar 126, a laser rangefinder 128, and a camera 130. The sensor system 104 may further include a sensor that monitors an internal system of the self-driving apparatus 100 (for example, a vehicle-mounted air quality monitor, a fuel gauge, or an oil temperature gauge). One or more pieces of sensor data from these sensors may be used to detect an object and corresponding features (a location, a shape, a direction, a speed, and the like) of the object. Detection and recognition are key functions for implementing a secure operation by the self-driving apparatus 100.

The positioning system 122 can be configured to estimate a geographical location of the self-driving apparatus 100. The IMU 124 is configured to sense a location and an orientation change of the self-driving apparatus 100 based on inertial acceleration. In an embodiment, the IMU 124 may be a combination of an accelerometer and a gyroscope.

The radar 126 may sense an object in the ambient environment of the self-driving apparatus 100 by using a radio signal. In some embodiments, in addition to sensing the object, the radar 126 may further be configured to sense a speed and/or a moving direction of the object.

The radar 126 may include an electromagnetic wave transmitting portion and receiving portion. The radar 126 may be implemented as a pulse radar mode or a continuous wave radar mode in a principle of radio wave transmission. The radar 126 in the continuous wave radar mode may be implemented as a frequency modulated continuous wave (FMCW) mode or a frequency shift keying (FSK) mode based on a signal waveform.

The radar 126 may use an electromagnetic wave as a medium, to detect an object based on a time of flight (TOF) manner or a phase-shift manner, and detect a location of the detected object, a distance from the detected object, and a relative speed of the detected object. To detect an object located before, behind, or beside a vehicle, the radar 126 may be configured at an appropriate location of an exterior of the vehicle. The radar 126 may use a laser as a medium, to detect an object based on a TOF manner or a phase-shift manner, and detect a location of the detected object, a distance from the detected object, and a relative speed of the detected object.

In an embodiment, to detect an object located before, behind, or beside a vehicle, the radar 126 may be configured at an appropriate location of an exterior of the vehicle.

The laser rangefinder 128 may use a laser to sense an object in an environment in which the self-driving apparatus 100 is located. In some embodiments, the laser rangefinder 128 may include one or more laser sources, a laser scanner, one or more detectors, and another system component.

The camera 130 can be configured to capture a plurality of images of the ambient environment of the self-driving apparatus 100. The camera 130 may be a static camera or a video camera.

In an embodiment, to obtain a video of the exterior of the vehicle, the camera 130 may be at an appropriate location of the exterior of the vehicle. For example, to obtain a video of a front of the vehicle, the camera 130 may be configured in close proximity to a front windshield inside the vehicle. Alternatively, the camera 130 may be configured around a front bumper or a radiator grille. For example, to obtain a video of a rear of the vehicle, the camera 130 may be configured in close proximity to rear window glass inside the vehicle. Alternatively, the camera 130 may be configured around a rear bumper, a trunk, or a tailgate. For example, to obtain a video of a side of the vehicle, the camera 130 may be configured in close proximity to at least one side window inside the vehicle. Alternatively, the camera 130 may be configured around a side mirror, a mudguard, or a car door.

The control system 106 controls operations of the self-driving apparatus 100 and components of the self-driving apparatus 100. The control system 106 may include various elements, including a steering system 132, a throttle 134, a brake unit 136, a sensor fusion algorithm 138, a computer vision system 140, a route control system 142, and an obstacle avoidance system 144.

The steering system 132 is operable to adjust a forward direction of the self-driving apparatus 100. For example, in an embodiment, the steering system 132 may be a steering wheel system.

The throttle 134 is configured to control an operating speed of the engine 118 and further control a speed of the self-driving apparatus 100.

The brake unit 136 is configured to control the self-driving apparatus 100 to decelerate. The brake unit 136 may use friction to slow down the wheels 121. In another embodiment, the brake unit 136 may convert kinetic energy of the wheels 121 into a current. The brake unit 136 may alternatively use another form to reduce a rotational speed of the wheels 121, so as to control the speed of the self-driving apparatus 100.

The computer vision system 140 may operate to process and analyze an image captured by the camera 130, so as to recognize objects and/or features in the ambient environment of the self-driving apparatus 100. The objects and/or features may include traffic signals, road boundaries, and obstacles. The computer vision system 140 may use an object recognition algorithm, a structure from motion (SFM) algorithm, video tracking, and other computer vision technologies. In some embodiments, the computer vision system 140 may be configured to: draw a map for an environment, track an object, estimate a speed of the object, and the like.

The route control system 142 is configured to determine a driving route of the self-driving apparatus 100. In some embodiments, the route control system 142 may determine the driving route for the self-driving apparatus 100 with reference to data from the sensor, the positioning system 122, and one or more predetermined maps.

The obstacle avoidance system 144 is configured to identify, evaluate, and avoid or otherwise bypass a potential obstacle in an environment of the self-driving apparatus 100.

Certainly, for example, the control system 106 may add or alternatively include components in addition to those shown and described. Alternatively, the control system 106 may not include some of the foregoing components.

The self-driving apparatus 100 interacts with an external sensor, another self-driving apparatus, another computer system, or a user through the peripheral device 108. The peripheral device 108 may include a wireless communication system 146, a vehicle-mounted computer 148, a microphone 150, and/or a speaker 152.

In some embodiments, the peripheral device 108 provides means for a user of the self-driving apparatus 100 to interact with the user interface 116. For example, the vehicle-mounted computer 148 may provide information for the user of the self-driving apparatus 100. The user interface 116 may further operate the vehicle-mounted computer 148 to receive user input. The vehicle-mounted computer 148 may perform operations through a touchscreen. In other cases, the peripheral device 108 may provide means used by the self-driving apparatus 100 to communicate with another device located in a vehicle. For example, the microphone 150 may receive audio (for example, a voice command or another audio input) from the user of the self-driving apparatus 100. Likewise, the speaker 152 may output audio to the user of the self-driving apparatus 100.

The wireless communication system 146 may communicate with one or more devices directly or through a communication network. For example, the wireless communication system 146 may use third generation (3G) cellular communication such as code division multiple access (CDMA), EVDO, or global system for mobile communication (GSM)/general packet radio service (GPRS), or fourth generation (4G) cellular communication such as long term evolution (LTE), or fifth generation (5G) cellular communication. The wireless communication system 146 may communicate with a wireless local area network (WLAN) by using Wi-Fi. In some embodiments, the wireless communication system 146 may directly communicate with a device by using an infrared link, Bluetooth, or ZigBee. For other wireless protocols such as various self-driving apparatus communication systems, the wireless communication system 146 may include, for example, one or more dedicated short-range communication (DSRC) devices. These devices may include self-driving apparatuses and/or apparatuses at roadside stations that perform public and/or private data communication with each other.

The power supply 110 may supply power to the components of the self-driving apparatus 100. In an embodiment, the power supply 110 may be a rechargeable lithium-ion or lead-acid battery. One or more battery packs of such a battery may be configured as a power supply to supply power to the components of the self-driving apparatus 100. In some embodiments, the power supply 110 and the energy source 119 may be implemented together, for example, in some pure electric vehicles.

Some or all functions of the self-driving apparatus 100 are controlled by the computer system 112. The computer system 112 may include at least one processor 113. The processor 113 executes instructions 115 stored in a non-transitory computer-readable medium such as a memory 114. The computer system 112 may alternatively be a plurality of computing devices that control individual components or subsystems of the self-driving apparatus 100 in a distributed manner.

The processor 113 may be any conventional processor, such as a commercially available central processing unit (CPU). Optionally, the processor may be a dedicated device, for example, an application-specific integrated circuit (ASIC) or another hardware-based processor. Although FIG. 1 functionally illustrates the processor, the memory, and other elements of a computer 110 in a same block, a person of ordinary skill in the art should understand that the processor, the computer, or the memory may actually include a plurality of processors, computers, or memories that may or may not be stored in a same physical housing. For example, the memory may be a hard disk drive, or another storage medium located in a housing different from that of the computer 110. Therefore, a reference to the processor or the computer will be understood as including a reference to a set of processors, computers, or memories that may or may not operate in parallel. Different from using a single processor to perform the operations described herein, some components such as a steering component and a deceleration component may include respective processors. The processor performs only computation related to a component-specific function.

In the aspects described herein, the processor may be located far away from the self-driving apparatus and perform wireless communication with the self-driving apparatus. In other aspects, some of the processes described herein are performed on the processor disposed inside the self-driving apparatus, while others are performed by a remote processor. The processes include necessary operations for performing a single operation.

In some embodiments, the memory 114 may include the instructions 115 (for example, program logic), and the instructions 115 may be executed by the processor 113 to perform various functions of the self-driving apparatus 100, including those functions described above. The memory 114 may also include additional instructions, including instructions used to send data to, receive data from, interact with, and/or control one or more of the travel system 102, the sensor system 104, the control system 106, and the peripheral device 108.

In addition to the instructions 115, the memory 114 may further store data such as road maps, route information, a location, direction, and speed of the self-driving apparatus, data of other self-driving apparatuses of this type, and other information. Such information may be used by the self-driving apparatus 100 and the computer system 112 when the self-driving apparatus 100 operates in an autonomous mode, a semi-autonomous mode, and/or a manual mode.

The user interface 116 is configured to provide information for or receive information from the user of the self-driving apparatus 100. In an embodiment, the user interface 116 may include one or more input/output devices within a set of peripheral devices 108, such as the wireless communication system 146, the vehicle-mounted computer 148, the microphone 150, and the speaker 152.

The computer system 112 may control functions of the self-driving apparatus 100 based on input received from each of the subsystems (for example, the travel system 102, the sensor system 104, and the control system 106) and from the user interface 116. For example, the computer system 112 may use input from the control system 106 to control the steering system 132 to avoid an obstacle detected by the sensor system 104 and the obstacle avoidance system 144. In some embodiments, the computer system 112 is operable to provide control over many aspects of the self-driving apparatus 100 and the subsystems of the self-driving apparatus 100.

In an embodiment, one or more of the foregoing components may be installed separately from or associated with the self-driving apparatus 100. For example, the memory 114 may be partially or completely separated from the self-driving apparatus 100. The foregoing components may be communicatively coupled together in a wired and/or wireless manner.

In an embodiment, the foregoing components are merely examples. In actual application, components in the foregoing modules may be added or deleted based on an actual requirement. FIG. 1 should not be understood as a limitation on this embodiment of this application.

A self-driving car traveling on a road, such as the foregoing self-driving apparatus 100, may recognize an object in an ambient environment of the self-driving apparatus 100 to determine adjustment on a current speed. The object may be another self-driving apparatus, a traffic control device, or another type of object. In some examples, each recognized object may be considered independently, and a speed to be adjusted to by a self-driving car may be determined based on features of the object, such as a current speed of the object, an acceleration of the object, and a distance between the object and the self-driving apparatus.

In an embodiment, the self-driving apparatus 100 or a computing device (for example, the computer system 112, the computer vision system 140, and the memory 114 in FIG. 1) associated with the self-driving apparatus 100 may predict an action of the recognized object based on features of the recognized object and a status of an ambient environment (for example, traffic, rain, or ice on a road). In an embodiment, all the recognized object depends on behavior of each other, and therefore, all the recognized objects may be considered together to predict behavior of a single recognized object. The self-driving apparatus 100 can adjust the speed of the self-driving apparatus 100 based on the predicted behavior of the recognized object. In other words, the self-driving car can determine, based on the predicted action of the object, a specific stable state (for example, acceleration, deceleration, or stop) to which the self-driving apparatus needs to be adjusted. In this process, another factor may also be considered to determine the speed of the self-driving apparatus 100, for example, a horizontal location of the self-driving apparatus 100 on a road on which the self-driving apparatus 100 travels, a curvature of the road, and proximity between a static object and a dynamic object.

In addition to providing instructions for adjusting the speed of the self-driving car, the computing device may further provide instructions for modifying a steering angle of the self-driving apparatus 100, so that the self-driving car can follow a given track and/or maintain safe horizontal and vertical distances from objects (for example, a car on a neighboring lane of the road) near the self-driving car.

The self-driving apparatus 100 may be a car, a truck, a motorcycle, a bus, a boat, an airplane, a helicopter, a lawn mower, a recreational vehicle, a playground vehicle, a construction device, a trolley, a golf cart, a train, a handcart, or the like. This is not limited in this embodiment of this application.

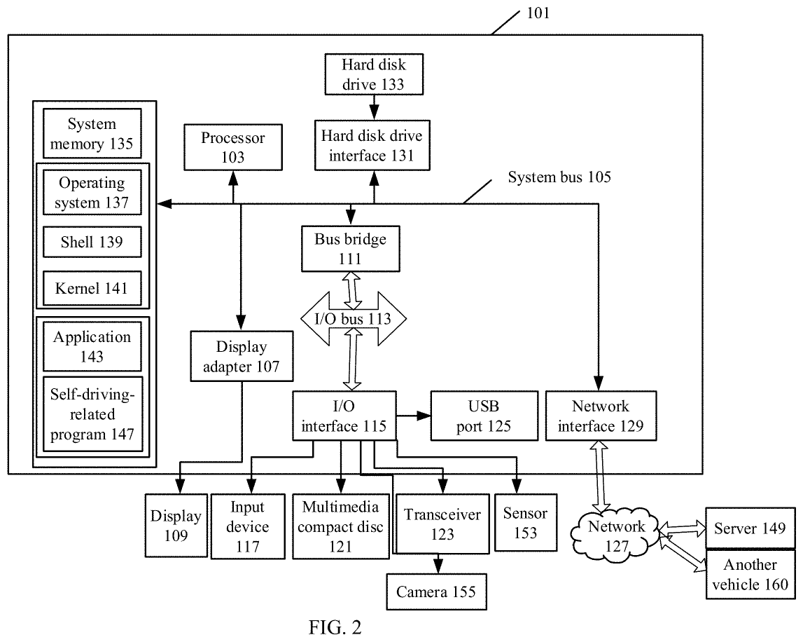

FIG. 1 is a functional block diagram of the self-driving apparatus 100. The following describes a self-driving system 101 in the self-driving apparatus 100. FIG. 2 is a schematic diagram of a structure of a self-driving system according to an embodiment of this application. FIG. 1 and FIG. 2 describes the self-driving apparatus 100 from different perspectives. For example, the computer system 101 in FIG. 2 is the computer system 112 in FIG. 1.

As shown in FIG. 2, the computer system 101 includes a processor 103, and the processor 103 is coupled to a system bus 105. The processor 103 may be one or more processors, and each processor may include one or more processor cores. The system bus 105 is coupled to an input/output (I/O) bus 113 through a bus bridge 111. An I/O interface 115 is coupled to the I/O bus. The I/O interface 115 communicates with a plurality of I/O devices, such as an input device 117 (such as a keyboard, a mouse, or a touchscreen), a multimedia compact disc (multimedia compact disc) 121, such as a CD-ROM or a multimedia interface. A transceiver 123 (which may send and/or receive a radio communication signal), a camera 155 (which may capture a scenery and a dynamic digital video image), and an external USB port 125 are included. Optionally, an interface connected to the I/O interface 115 may be a USB port.

The processor 103 may be any conventional processor, including a reduced instruction set computing (“RISC”) processor, a complex instruction set computing (“CISC”) processor, or a combination thereof. Optionally, the processor may be a dedicated apparatus such as an application-specific integrated circuit (“ASIC”). Optionally, the processor 103 may be a neural-network processing unit (Neural-network Processing Unit, NPU) or a combination of a neural-network processing unit and the foregoing conventional processor. Optionally, a neural-network processing unit is disposed on the processor 103.

The computer system 101 may communicate with a server 149 through a network interface 129. The network interface 129 is a hardware network interface, for example, a network interface card. A network 127 may be an external network such as the Internet, or an internal network such as the Ethernet or a virtual private network (VPN). Optionally, the network 127 may alternatively be a wireless network, for example, a Wi-Fi network or a cellular network.

The server 149 may be a high-precision map server, and the vehicle may obtain high-precision map information by communicating with a high-precision map server.

The server 149 may be a vehicle management server. The vehicle management server may be configured to process data uploaded by the vehicle, and may deliver data to the vehicle through a network.

In addition, the computer system 101 may perform wireless communication with another vehicle 160 (V2V) or a pedestrian (V2P) through the network interface 129.

A hard disk drive interface is coupled to the system bus 105. A hardware driver interface is connected to a hard disk drive. A system memory 135 is coupled to the system bus 105. Data running in the system memory 135 may include an operating system 137 and an application 143 of the computer system 101.

The operating system includes a shell 139 and a kernel 141. The shell 139 is an interface between a user and the kernel of the operating system. The shell 139 is an outermost layer of the operating system. The shell 139 manages interaction between the user and the operating system: waiting for input of the user, explaining the input of the user to the operating system, and processing output results of various operating systems.

The kernel 141 includes components of the operating system that are configured to manage a memory, a file, a peripheral, and system resources. The kernel directly interacts with hardware. The kernel of the operating system usually runs processes, provides communication between the processes, and provides CPU time slice management, interruption, memory management, I/O management, and the like.

The application 143 includes a self-driving-related program, for example, a program for managing interaction between a self-driving apparatus and an obstacle on a road, a program for controlling a driving route or speed of a self-driving apparatus, or a program for controlling interaction between a self-driving apparatus 100 and another self-driving apparatus on the road.

A sensor 153 is associated with the computer system 101. The sensor 153 is configured to detect an ambient environment of the computer system 101. For example, the sensor 153 can detect animals, automobiles, obstacles, pedestrian crosswalks, and the like. Further, the sensor can detect ambient environments of the animals, the automobiles, the obstacles, or the pedestrian crosswalks. For example, the sensor can detect the ambient environment of animals such as other animals in the ambient environment, a weather condition, and brightness of the ambient environment. In an embodiment, if the computer system 101 is located on the self-driving apparatus, the sensor may be a camera, an infrared sensor, a chemical detector, a microphone, or the like. When being activated, the sensor 153 senses information at preset intervals, and provides the sensed information for the computer system 101 in real time or near real time.

The computer system 101 is configured to: determine a driving status of the self-driving apparatus 100 based on sensor data collected by the sensor 153; determine, based on the driving status and a current driving task, a driving operation that needs to be executed by the self-driving apparatus 100; and send, to the control system 106 (which is shown in FIG. 1), control instructions corresponding to the driving operation. The driving status of the self-driving apparatus 100 may include a driving situation of the self-driving apparatus 100, for example, a head direction, a speed, a location, and an acceleration, and may also include a status of the ambient environment of the self-driving apparatus 100, for example, a location of an obstacle, a location and a speed of another vehicle, a location of a pedestrian crosswalk, or a signal of a traffic light. The computer system 101 may include a task abstraction network and a shared policy network that are implemented by the processor 103. Specifically, the processor 103 determines a current self-driving task. The processor 103 inputs at least one group of historical paths of the self-driving task to the task abstraction network for feature extraction, to obtain a task feature vector representing features of the self-driving task. The processor 103 determines, based on the sensor data collected by the sensor 153, a status vector representing a current driving status of the self-driving apparatus. The processor 103 inputs the task feature vector and the status vector into the shared policy network for processing, to obtain a driving operation that needs to be performed currently by the self-driving apparatus. The processor 103 performs the driving operation through the control system. The processor 103 repeats the foregoing operations of determining and performing the driving operation, until the self-driving task is completed.

In an embodiment, the computer system 101 may be located far away from the self-driving apparatus, and may perform wireless communication with the self-driving apparatus. The transceiver 123 may send a self-driving task, the sensor data collected by the sensor 153, and other data to the computer system 101, and may further receive control instructions sent by the computer system 101. The self-driving apparatus may execute the control instructions received by the transceiver from the computer system 101, and perform a corresponding driving operation. In other aspects, some of the processes described in this specification are performed on a processor disposed inside a self-driving vehicle, and others are performed by a remote processor, including taking actions required to perform a single operation.

As shown in FIG. 2, a display adapter 107 may drive a display 109, and the display 109 is coupled to the system bus 105. The display 109 may be used for visual display and audio playing of information entered by or provided for a user, and various menus of a vehicle-mounted device. The display 109 may include at least one of a liquid crystal display (LCD), a thin film transistor liquid crystal display (TFT LCD), an organic light-emitting diode (OLED), a flexible display, a 3D display, and an electronic ink display (e-ink display). The touch panel may cover the display 109. When detecting the touch operation on or near the touch panel, the touch panel sends the touch operation to the processor to determine a type of a touch event, and then the processor provides corresponding visual output on the display 109 based on the type of the touch event. In addition, the touch panel and the display 109 may alternatively be integrated to implement input and output functions of the vehicle-mounted device.

Moreover, the display 109 may be implemented by a head-up display (HUD). Furthermore, the display 109 may be provided with a projection module to output information by projecting an image on a windshield or a car window. The display 109 may include a transparent display. The transparent display may be attached to the windshield or the car window. The transparent display may display a specified picture with specified transparency. To make the transparent display have transparency, the transparent display may include at least one of a transparent thin film electroluminescent (TFEL) display, a transparent organic light-emitting diode (OLED), a transparent LCD, a transmissive transparent display, and a transparent LED (Light Emitting Diode) display. The transparency of the transparent display is adjustable.

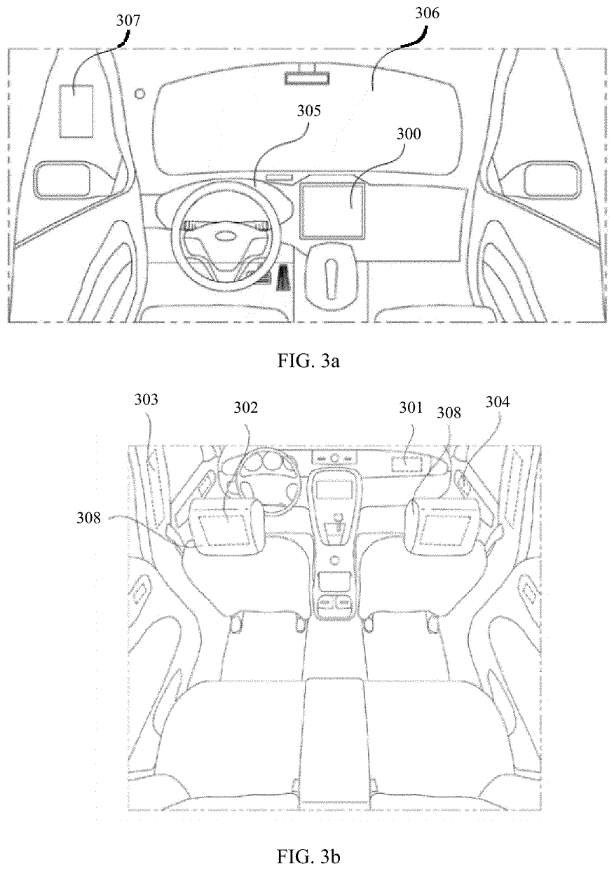

In addition, the display 109 may be configured in a plurality of areas inside the vehicle. FIG. 3a and FIG. 3b show an internal structure of a vehicle according to an embodiment of this application. As shown in FIG. 3a and FIG. 3b, the display 109 may be configured in areas 300 and 301 of a dashboard, an area 302 of a seat 308, an area 303 of pillar trims, an area 304 of a car door, an area 305 of a center console, an area of a head lining, or an area of a sunvisor, or may be implemented in an area 306 of a windshield or an area 307 of a car window. It should be noted that the foregoing configuration locations of the display 109 are merely examples, and do not constitute any limitation on this application.

In an embodiment of this application, the display may display a human-computer interaction interface, for example, may display a self-driving interface during self-driving of the vehicle.

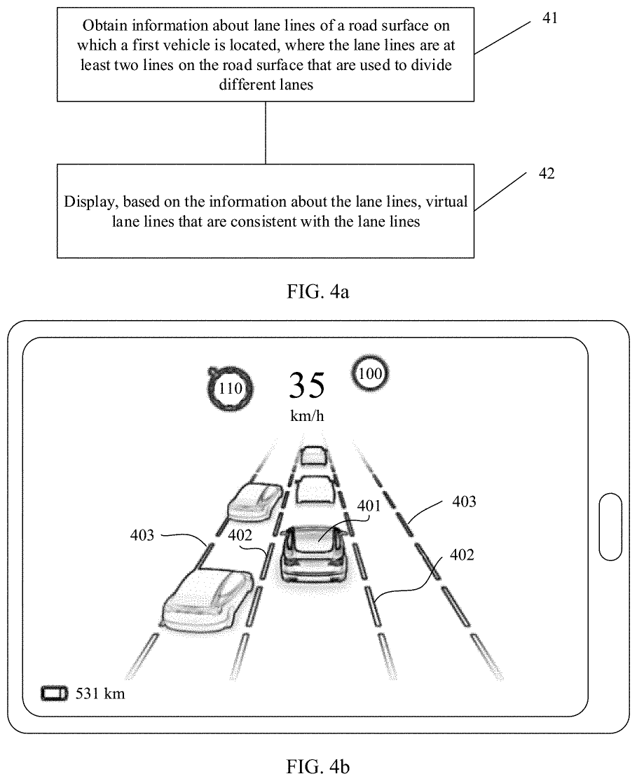

FIG. 4a is a schematic flowchart of a vehicle-mounted device information display method according to an embodiment of this application. As shown in FIG. 4a, the vehicle-mounted device information display method includes the following operations.

41: Obtain information about lane lines of a road surface on which a first vehicle is located, where the lane lines are at least two lines on the road surface that are used to divide different lanes.

In an embodiment of this application, the lane line may be a traveling vehicle line, a vehicle line next to the traveling vehicle line, or a traveling vehicle line of a crossing vehicle. The lane lines may include left and right lines (lines) that form a lane (lane). In other words, the lane lines are at least two lines on the road surface that are used to divide different lanes.

In an embodiment, the first vehicle may obtain an external image or video of the vehicle by using a camera or another photographing device carried by the first vehicle, and send the obtained external image or video to a processor. The processor may obtain, according to a recognition algorithm, the information about the lane lines included in the external image or video.

In an embodiment, after obtaining an external image or video of the vehicle by using a camera or another photographing device carried by the first vehicle, the first vehicle may upload the image or video to a vehicle management server. The vehicle management server processes the image, and delivers a recognition result (the information about the lane lines) to the first vehicle.

In an embodiment, the first vehicle may detect an ambient environment of a vehicle body by using a sensor (for example, a radar or a laser radar) carried by the first vehicle, and obtain the information about the lane lines outside the vehicle.

In an embodiment, the first vehicle may obtain, from a high-precision map server, the information about the lane lines of the road surface on which the first vehicle currently travels.

In an embodiment, the first vehicle may determine lane line-related information based on other data (for example, based on a current traveling speed or historical traveling data).

In this embodiment of this application, the information about the lane lines may be image information of the lane lines.

42: Display, based on the information about the lane lines, virtual lane lines whose types are consistent with those of the lane lines.

In an embodiment of this application, during self-driving of the vehicle, the display 109 may display a self-driving interface. Specifically, after the information about the lane lines of the road surface on which the first vehicle is located is obtained, the virtual lane lines whose types are consistent with those of the lane lines may be displayed on the self-driving interface.

FIG. 4b is a schematic diagram of a self-driving interface according to an embodiment of this application. As shown in FIG. 4b, the self-driving interface includes a first vehicle 401, virtual lane lines 402, and virtual lane lines 403. The virtual lane lines 402 are lane lines of a lane in which the first vehicle is located. The virtual lane lines 403 are not virtual lane lines corresponding to the lane lines of the lane in which the first vehicle 401 is located, but are also virtual lane lines corresponding to lane lines of a road surface on which the first vehicle 401 is located.

In an embodiment, only the virtual lane lines corresponding to the lane lines of the lane in which the first vehicle 401 is located (for example, the virtual lane lines 402 shown in FIG. 4) may alternatively be displayed on the self-driving interface.

In this embodiment of this application, types of the virtual lane lines displayed on the self-driving interface may be consistent with those of the actual lane lines, and specifically, shapes thereof may be consistent. Specifically, the lane lines include at least one of the following lane lines: a dashed line, a solid line, a double dashed line, a double solid line, and a dashed solid line.

In an embodiment, types of the virtual lane lines displayed on the self-driving interface may be consistent with those of the actual lane lines, and specifically, shapes and colors thereof may be consistent. Specifically, the lane lines include at least one of the following lane lines: a dashed white line, a solid white line, a dashed yellow line, a solid yellow line, a double dashed white line, a double solid yellow line, a dashed solid yellow line, and a double solid white line.

For example, a double solid yellow line is drawn on a center of a road to separate a traffic flow traveling in opposite directions.

A solid yellow line is drawn on a center of a road to separate a traffic flow traveling in opposite directions, or serves as a marking line for a bus or school bus special stop and is drawn on a roadside to indicate prohibition of parking on the roadside.

A solid white line is drawn on a center of a road to separate motor vehicles and non-motor vehicles traveling in a same direction or indicate an edge of a lane, and is drawn on an intersection to serve as a guide lane line or a stopline or guide a vehicle traveling track.

A dashed solid yellow line is drawn on a center of a road to separate a traffic flow traveling in opposite directions. A solid line side prohibits vehicles from crossing the line, and a dashed line side allows vehicles to cross the line temporarily.

In addition, the lane lines may further include a diversion line, a grid line, and the like. The diversion line may be one or more types of lines, that is, a V-shaped white line or a diagonal line area, disposed based on an intersection terrain, is used for excessively wide or irregular crossroads or crossroads with relatively complicated traveling conditions and interchange ramps or other special places, and indicates that vehicles need to travel along a stipulated route without traveling on the line or across the line. The yellow grid line indicates an area in which parking is prohibited, and indicates exclusive parking spaces when used as a marking line for parking spaces. This means that vehicles are allowed to pass through the line normally, but are not allowed to stay on the line.

It should be understood that the self-driving interface may further include other display elements, for example, a current traveling speed of the first vehicle, a speed limit of a current road surface, and other vehicles. This is not limited in this application.

It should be noted that “consistent” in this embodiment does not emphasize that the virtual lane lines are exactly the same as the lane lines of the road surface, and there may always be some differences between the virtual lane lines displayed by using a computer screen and the actual lane lines. This application is intended to indicate an actual lane to a driver for reference. The lane lines indicated in an indication manner are close to the actual lane lines as much as possible. However, presented effects of the lines may be different from those of the actual lane lines in terms of a color, a shape, a material, and the like. Further, other indication information may be displayed in addition to the virtual lane lines.

In an embodiment of this application, the virtual lane lines consistent with the lane lines corresponding to the obtained information about the lane lines are displayed on the self-driving interface, so that the driver can see, from the self-driving interface, the virtual lane lines corresponding to the types of the actual lane lines of the traveling road surface in this case. This not only enriches display content of the self-driving interface, but also improves driving safety.

In an embodiment, the first vehicle may further obtain information about a non-motor vehicle object on the road surface; and display, based on the information about the non-motor vehicle object, an identifier corresponding to the non-motor vehicle object.

In an embodiment of this application, the non-motor vehicle object includes at least a road depression, an obstacle, and a road water accumulation, and may further include a pedestrian, a two-wheeled vehicle, a traffic signal, a street lamp, various plants such as a tree, a building, a utility pole, a signal lamp, a bridge, a mountain, a hill, and the like. This is not limited herein.

In an embodiment, the first vehicle may obtain the external image or video of the vehicle by using the camera or the another photographing device carried by the first vehicle, and send the obtained external image or video to the processor. The processor may obtain, according to the recognition algorithm, the information about the non-motor vehicle object included in the external image or video.

In an embodiment, after obtaining the external image or video of the vehicle by using the camera or the another photographing device carried by the first vehicle, the first vehicle may upload the image or video to the vehicle management server. The vehicle management server processes the image, and delivers a recognition result (the information about the non-motor vehicle object) to the first vehicle.

In an embodiment, the first vehicle may detect the ambient environment of the vehicle body by using the sensor (for example, a radar or a laser radar) carried by the first vehicle, and obtain the information about the non-motor vehicle object outside the vehicle.

In an embodiment of this application, after the information about the non-motor vehicle object on the road surface is obtained, the identifier corresponding to the non-motor vehicle object may be displayed on an autonomous navigation interface. Specifically, the information about the non-motor vehicle object may include a location, a shape, a size, and the like of the non-motor vehicle object. Correspondingly, the identifier corresponding to the non-motor vehicle object may be displayed at a corresponding location of the non-motor vehicle object based on the shape and the size of the non-motor vehicle object.

It should be noted that the identifier corresponding to the non-motor vehicle object may be consistent with the non-motor vehicle object, or may be used as an example and is merely used to indicate the shape and the size of the non-motor vehicle object.

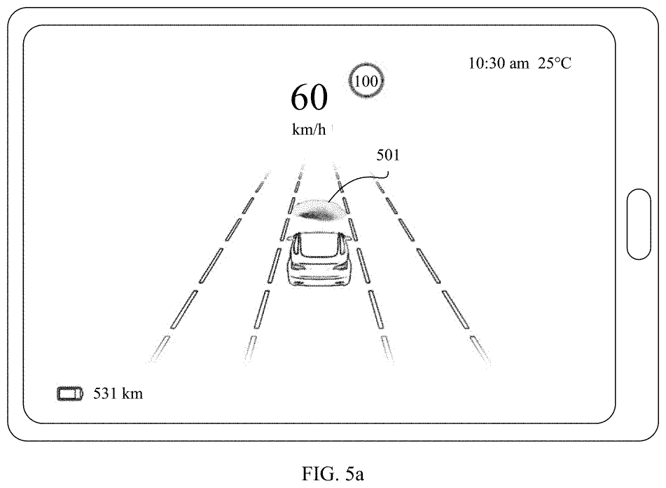

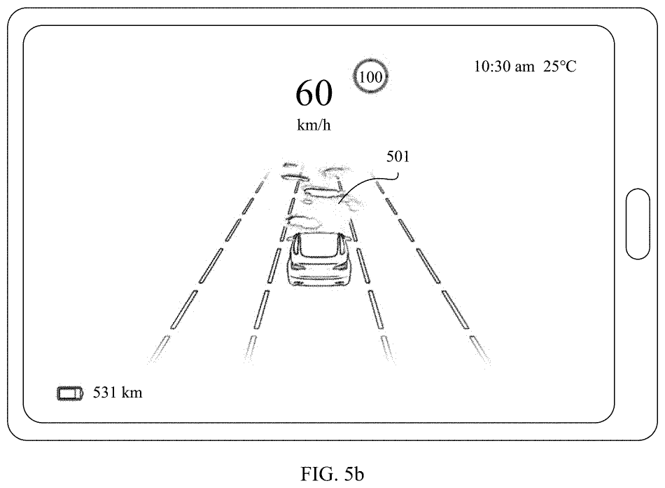

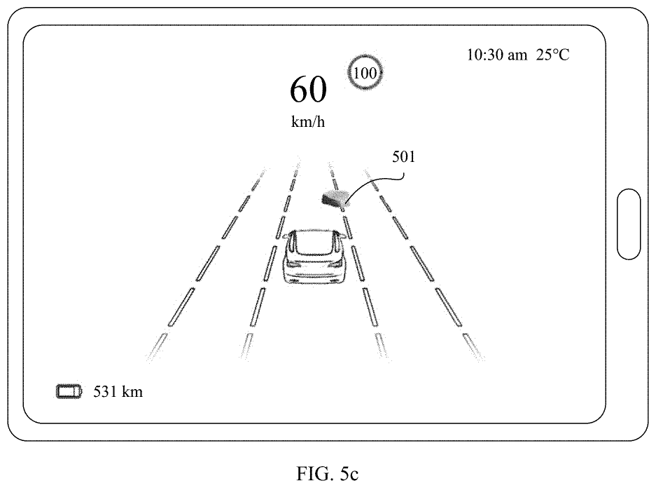

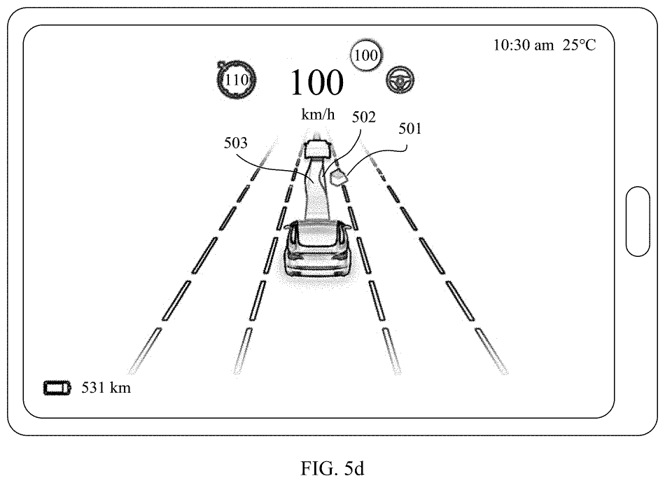

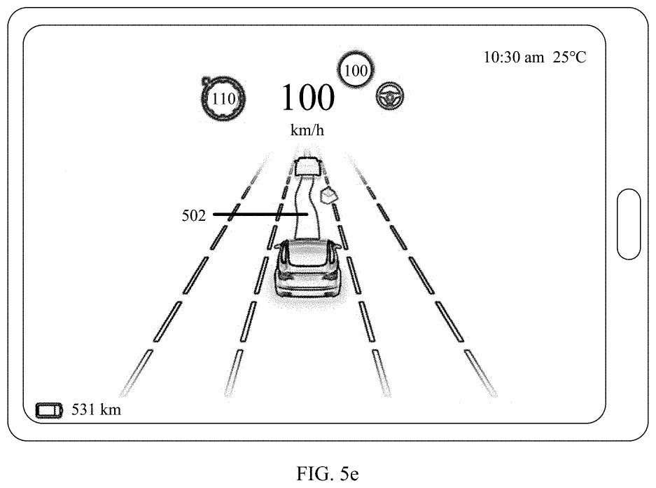

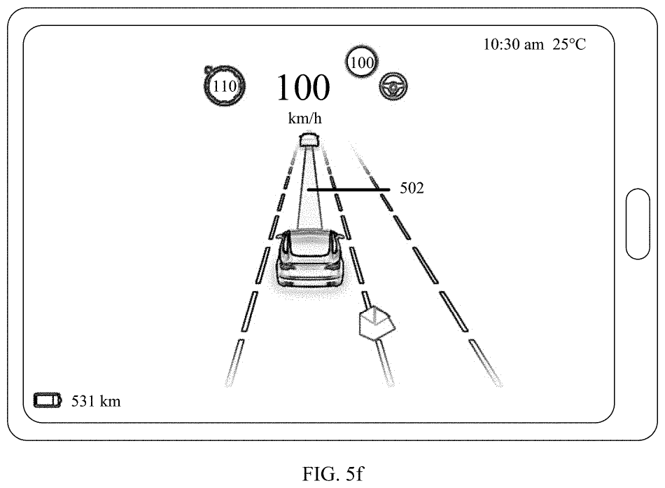

FIG. 5a is a schematic diagram of a self-driving interface according to an embodiment of this application. As shown in FIG. 5a, the self-driving interface further includes a non-motor vehicle object 501 (a road depression).

FIG. 5b is a schematic diagram of a self-driving interface according to an embodiment of this application. As shown in FIG. 5b, the self-driving interface further includes a non-motor vehicle object 501 (a road water accumulation).

FIG. 5c is a schematic diagram of a self-driving interface according to an embodiment of this application. As shown in FIG. 5c, the self-driving interface further includes a non-motor vehicle object 501 (an obstacle).

In an embodiment, a lane change indication may further be displayed when the non-motor vehicle object is located on a navigation path indicated by a navigation indication, where the navigation indication is used to indicate the navigation path of the first vehicle, and the lane change indication is used to instruct the first vehicle to avoid a traveling path of the non-motor vehicle object.

In an embodiment, when the first vehicle is in a navigation state, the first vehicle may display the navigation indication based on navigation information, where the navigation indication is used to indicate the navigation path of the first vehicle. In this case, when recognizing that the non-motor vehicle object is located on the navigation path indicated by the navigation indication, the first vehicle displays the lane change indication used to instruct the first vehicle to avoid the traveling path of the non-motor vehicle object.

It should be noted that, in an embodiment of this application, the first vehicle may obtain the external image or video of the vehicle by using the camera or the another photographing device carried by the first vehicle, and send the obtained external image or video to the processor. The processor may obtain, according to the recognition algorithm, the information about the non-motor vehicle object included in the external image or video. In this case, the information about the non-motor vehicle object may include the size, the shape, and the location of the non-motor vehicle object. The processor may determine, based on the obtained size, shape, and location of the non-motor vehicle object, whether the non-motor vehicle object is on the current navigation path.

In an embodiment, after obtaining the external image or video of the vehicle by using the camera or the another photographing device carried by the first vehicle, the first vehicle may upload the image or video to the vehicle management server. The vehicle management server processes the image, and delivers a recognition result (whether the non-motor vehicle object is on the current navigation path or whether the non-motor vehicle object obstructs vehicle traveling) to the first vehicle.

FIG. 5d is a schematic diagram of a self-driving interface according to an embodiment of this application. As shown in FIG. 5d, a non-motor vehicle object 501 (an obstacle) is located on a navigation path indicated by a navigation indication 502, and then a lane change indication 503 used to instruct the first vehicle to avoid the traveling path of the non-motor vehicle object is displayed.

It should be noted that, the lane change indication 503 may be a strip-shaped path instruction, or may be a linear path instruction. This is not limited herein.

In an embodiment of this application, the first vehicle may directly pass through a road depression and a road water accumulation, which is different from an obstacle. If there is an obstacle, the first vehicle needs to circumvent the obstacle. When the navigation indication is displayed, if there is an obstacle on the navigation path indicated by the navigation indication, the lane change indication 503 used to instruct the first vehicle to avoid the traveling path of the non-motor vehicle object may be displayed. The lane change indication 503 may be displayed in a color and/or shape different from those/that of the current navigation indication. The navigation indication 502 may be displayed as a curved indication (as shown in FIG. 5e) when the first vehicle detours and makes a lane change according to the lane change indication 503. The navigation indication 502 may be re-straightened for display (as shown in FIG. 5f) when the first vehicle circumvents the obstacle.

In an embodiment, a first alarm prompt may further be displayed when a distance between the first vehicle and the non-motor vehicle object is a first distance; and a second alarm prompt may further be displayed when the distance between the first vehicle and the non-motor vehicle object is a second distance, where the second alarm prompt is different from the first alarm prompt.

In an embodiment, a color or transparency of the first alarm prompt is different from that of the second alarm prompt.

Specifically, in this embodiment of this application, the first vehicle may obtain the distance between the first vehicle and the non-motor vehicle object by using a distance sensor, and display the alarm prompt based on the distance between the first vehicle and the non-motor vehicle object. The alarm prompt may change with at least two colors based on a distance to an obstacle (a collision danger level), and a smooth transition is made between two adjacent colors as the distance between the first vehicle and the obstacle increases/decreases.

In an embodiment, the first vehicle may further receive a sharing instruction, where the sharing instruction carries an address of a second vehicle; and send second shared information to the second vehicle in response to the sharing instruction, where the second shared information includes location information of the non-motor vehicle object.

In an embodiment, the first vehicle may further receive first shared information sent by a server or the second vehicle, where the first shared information includes the location information of the non-motor vehicle object; and an obstacle prompt is displayed on a navigation interface when the first vehicle enables navigation, where the obstacle prompt is used to indicate the non-motor vehicle object at a location corresponding to the location information.

It can be understood that if a road depression or a road water accumulation is relatively severe or an obstacle is relatively large, vehicle traveling may be seriously affected, and the driver may prefer to know the situation earlier rather than know it until the vehicle approaches the road depression, the road water accumulation, or the obstacle. In this case, predictions cannot be made by using only the sensor of the vehicle.

In an embodiment, after information about the road depression, the road water accumulation, or the obstacle is obtained by using a surveillance camera in a traffic system or a sensor of a vehicle that has traveled on the road surface, the information may be reported to the vehicle management server. The server delivers the information to vehicles on roads that include the road depression, the road water accumulation, or the obstacle in a navigation route, so that the vehicles can learn the information in advance.

If obtaining the information (the location, the shape, the size, and the like) about the non-motor vehicle object by using the sensor, the first vehicle may send the information about the non-motor vehicle object to another vehicle (the second vehicle). Specifically, the driver or a passenger may perform an operation on the self-driving interface (for example, triggering a sharing control on the display interface and entering the address of the second vehicle, or directly selecting the second vehicle that has established a connection to the first vehicle). Correspondingly, the first vehicle may receive the sharing instruction, where the sharing instruction carries the address of the second vehicle, and send the second shared information to the second vehicle in response to the sharing instruction, where the second shared information includes the location information of the non-motor vehicle object.

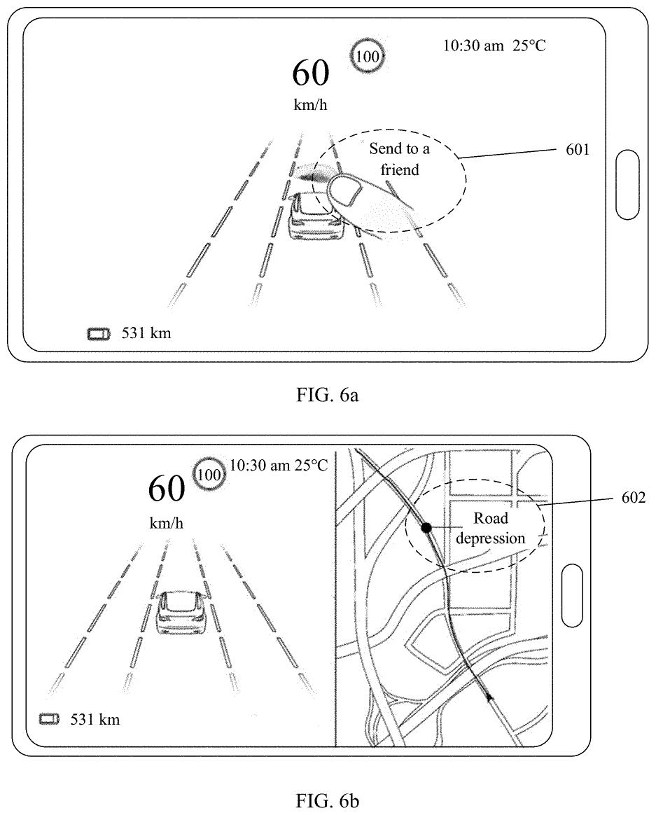

FIG. 6a is a schematic diagram of a self-driving interface according to an embodiment of this application. As shown in FIG. 6a, if a driver A and a driver B agree to travel to a specific place, the driver A starts first, and finds that there is a road depression on a road surface on a passing path. Then, the driver A may touch a display to click a depression prompt, select a sharing control 601 “send to a friend” (as shown in FIG. 6a), and select “the driver B” (which is equivalent to entering the address of the second vehicle in this case), so that the driver B can receive the road depression prompt in advance.

Correspondingly, an example in which the first vehicle receives shared information is used. The first vehicle receives the first shared information sent by the server or the second vehicle, where the first shared information includes the location information of the non-motor vehicle object; and the obstacle prompt is displayed on the navigation interface when the first vehicle enables navigation, where the obstacle prompt is used to indicate the non-motor vehicle object at the location corresponding to the location information.

FIG. 6b is a schematic diagram of a self-driving interface according to an embodiment of this application. As shown in FIG. 6b, a right figure in FIG. 6b is a navigation interface, the navigation interface includes a navigation map, a thick solid line in the figure is a navigation route, an arrow indicates a current location to which the vehicle travels, a location marked by a black dot on the thick solid line indicates road depression information collected by the vehicle management server or road depression information sent by another vehicle, and a depression prompt 602 is displayed on the current navigation interface of the first vehicle.

In this embodiment of this application, the first vehicle may further display different navigation indications based on traveling speeds.

In an embodiment, the first vehicle may further obtain the navigation information of the first vehicle, and display the navigation indication based on the navigation information, where the navigation indication is used to indicate the navigation path of the first vehicle.

In an embodiment of this application, the navigation indication includes a first navigation indication or a second navigation indication. The first navigation indication is displayed based on a stationary state of the first vehicle; and the second navigation indication is displayed based on a traveling state of the first vehicle, where the first navigation indication is different from the second navigation indication.

Specifically, a display color or display transparency of the first navigation indication is different from that of the second navigation indication.

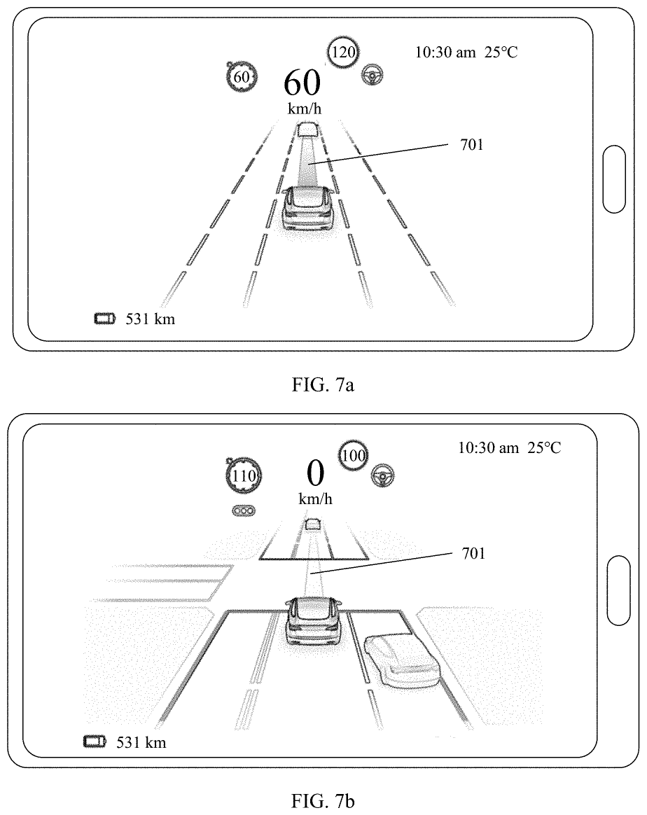

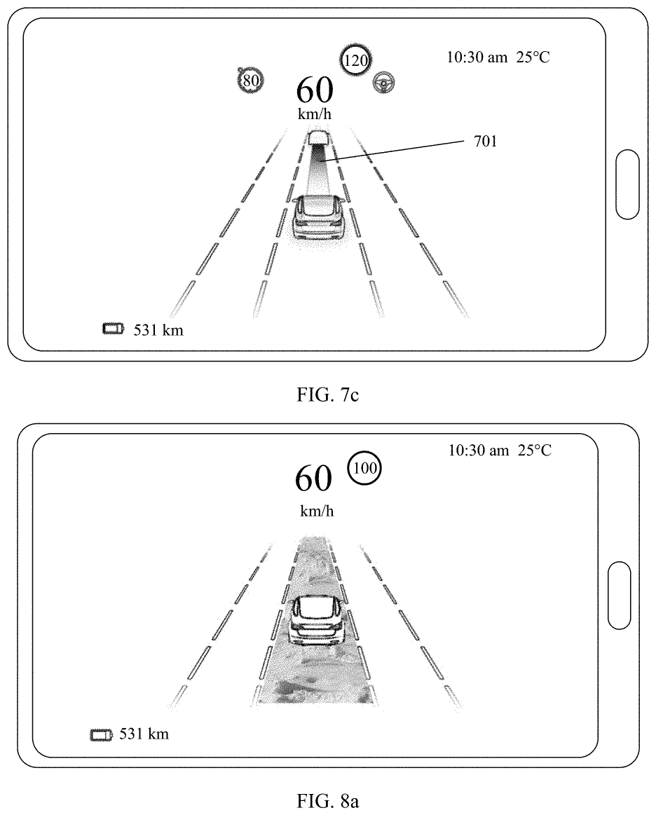

FIG. 7a is a schematic diagram of a self-driving interface according to an embodiment of this application. As shown in FIG. 7a, the self-driving interface includes a navigation indication 701, and the navigation indication 701 indicates a navigation path of the first vehicle. A first navigation indication 701 is displayed (as shown in FIG. 7b) when the first vehicle determines that a current state is a stationary state or that a traveling speed is lower than a preset speed. A second navigation indication 701 is displayed (as shown in FIG. 7c) when the first vehicle determines that a current state is a traveling state or that a traveling speed is higher than a preset speed. A color of the second navigation indication 701 shown in FIG. 7c is different from that of the first navigation indication 701 shown in FIG. 7b.

In an embodiment of this application, different navigation indications are displayed based on traveling statuses of the first vehicle, so that the driver or a passenger can determine a current traveling status of the vehicle based on display of the navigation indication on the navigation interface.

In an embodiment of this application, the first vehicle may further enable visual elements (e.g., virtual lane lines, road surfaces of lanes, navigation indications, and the like) on the autonomous navigation interface to change in at least one of a color, brightness, and a material based on a current environment (e.g., information about weather, time, and the like) in which the first vehicle is situated.

In an embodiment, the navigation indication includes a third navigation indication or a fourth navigation indication. The first vehicle may display the third navigation indication based on a first environment of the first vehicle; and display the fourth navigation indication based on a second environment of the first vehicle, where the first environment is different from the second environment, and the third navigation indication is different from the fourth navigation indication.

In another embodiment, the first vehicle may display a first lane based on the first environment of the first vehicle, and display a second lane based on the second environment of the first vehicle. The first lane and the second lane are lanes in which the first vehicle travels, or lanes of the road surface on which the first vehicle is located. The first environment is different from the second environment, and the first lane is different from the second lane.

In an embodiment, the first vehicle may enable the visual elements (the virtual lane lines, the road surfaces of the lanes, the navigation indications, and the like) on the autonomous navigation interface to change in the at least one of a color, brightness, and a material based on the current environment (the information about weather, time, and the like) in which the first vehicle is situated.

In an embodiment, the first environment includes at least one of the following environments: a weather environment in which the first vehicle is situated, a road surface environment in which the first vehicle is situated, a weather environment of a navigation destination of the first vehicle, a road surface environment of the navigation destination of the first vehicle, a traffic congestion environment of a road on which the first vehicle is located, a traffic congestion environment of the navigation destination of the first vehicle, or a brightness environment in which the first vehicle is situated.

The weather environment may be obtained by connecting a network to a weather server. The weather environment may include a temperature, humidity, a strong wind, a rainstorm, a snowstorm, and the like. The brightness environment may be brightness of the current environment in which the vehicle is situated, and may indicate current time. For example, if the current time is a morning, colors of the virtual lane lines, the road surfaces of the lanes, the navigation indications, and the like are increased compared with normal brightness or become lighter than normal brightness. If the current time is an evening, colors of the virtual lane lines, the road surfaces of the lanes, the navigation indications, and the like are decreased compared with normal brightness or become deeper than normal brightness.

For example, if the current time is a snowy day, materials of the virtual lane lines, the road surfaces of the lanes, the navigation indications, and the like are displayed as being covered by snow.

For example, when the current weather environment is severe weather (such as a strong wind, a rainstorm, or a snowstorm), the visual elements such as the virtual lane lines, the road surfaces of the lanes, and the navigation indications are enhanced for display. For example, colors are brighter (purity is improved), or brightness is increased, or enhanced materials are used.

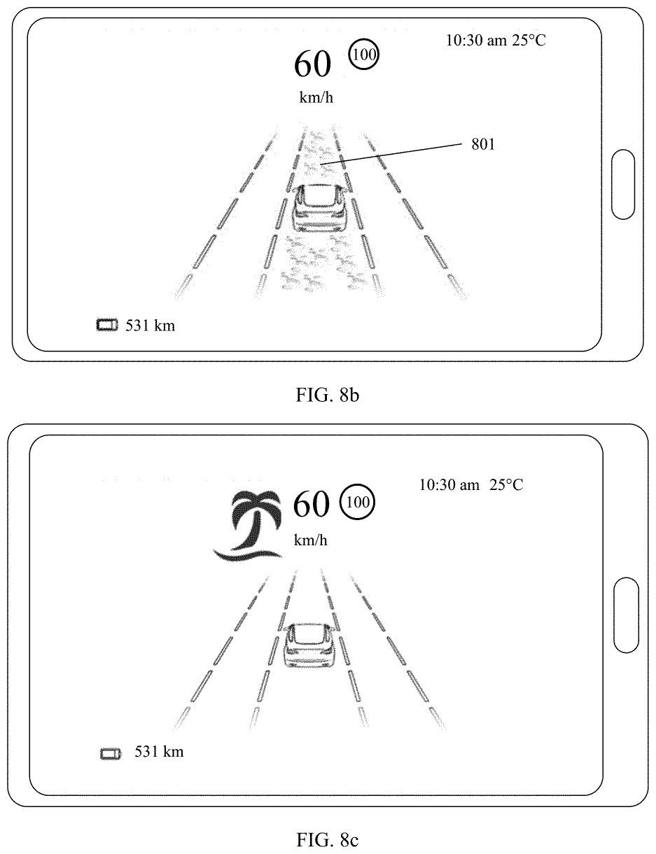

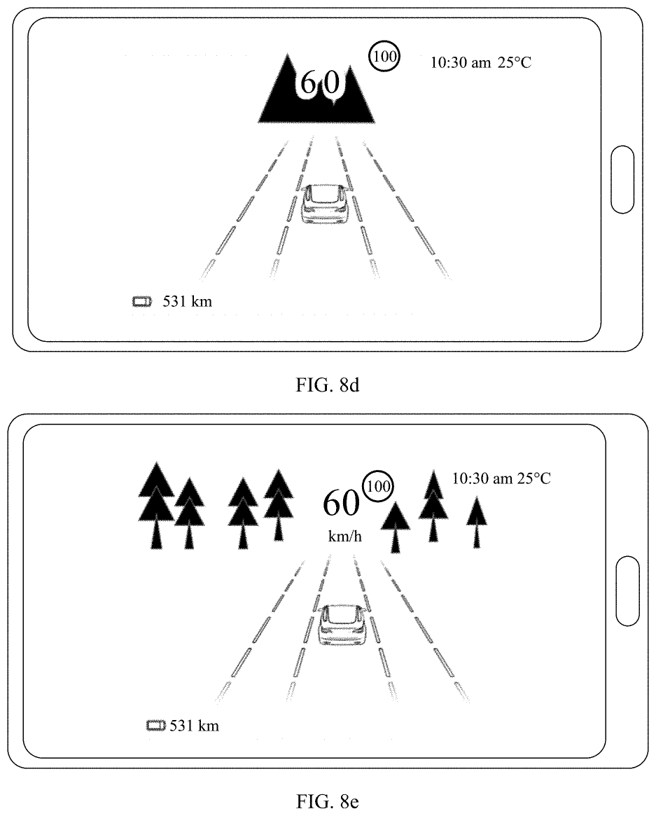

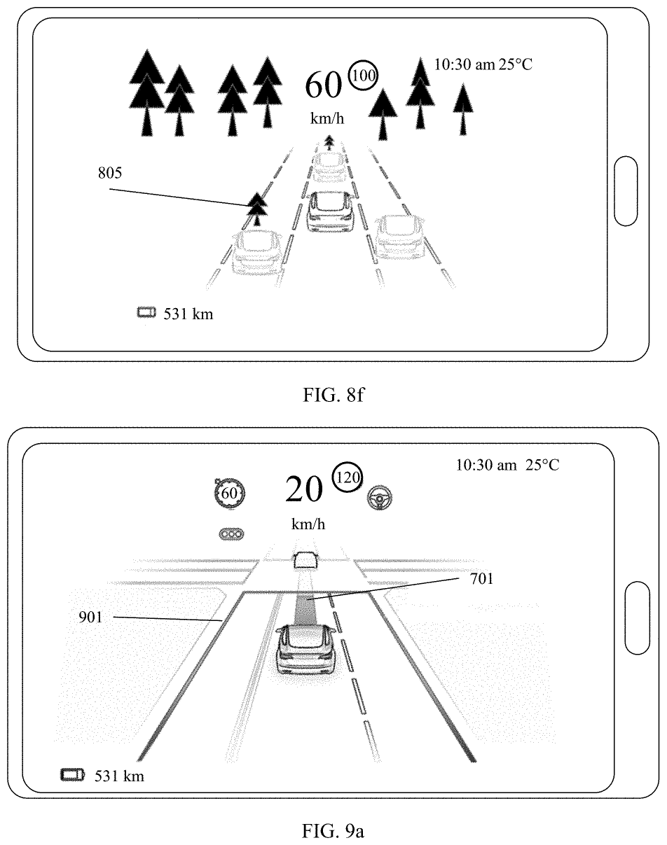

FIG. 8a is a schematic diagram of a self-driving interface according to an embodiment of this application. As shown in FIG. 8a, a road surface environment in which the first vehicle travels is snow, and correspondingly a road surface material on the autonomous navigation interface is displayed as being covered by snow.

FIG. 8b is a schematic diagram of a self-driving interface according to an embodiment of this application. As shown in FIG. 8b, a road surface environment in which the first vehicle travels is desert, and correspondingly a road surface material on the autonomous navigation interface is displayed as desert.

In an embodiment of this application, the first vehicle may display the first lane based on the first environment of the first vehicle, and display the second lane based on the second environment of the first vehicle. The first lane and the second lane are the lanes in which the first vehicle travels, or the lanes of the road surface on which the first vehicle is located. The first environment is different from the second environment, and the first lane is different from the second lane. The driver or a passenger can obtain, based on display of the autonomous navigation interface, the current environment in which the vehicle is situated, especially at night or in other scenarios with relatively low brightness. This improves driving safety.

In an embodiment of this application, the first vehicle may display a corresponding image on the self-driving interface based on a geographical location of a navigation destination.

In an embodiment, the first vehicle may obtain a geographical location of the navigation destination of the first vehicle, and display a first image based on the geographical location, where the first image is used to indicate a type of the geographical location of the navigation destination of the first vehicle. The type of the geographical location may include at least one of the following: city, mountain area, plain, forest, or seaside.

In an embodiment of this application, the first vehicle may obtain the geographical location of the navigation destination of the first vehicle by using a GPS system, or obtain the geographical location of the navigation destination of the current vehicle by using a high-definition map, and further obtain attribute information (types) of the geographical locations. For example, the geographical location of the navigation destination of the first vehicle may belong to a city, a mountain area, a plain, a forest, a seaside, or the like. The attribute information (types) of the geographical locations may be obtained from a map system.

In an embodiment of this application, after obtaining the geographical location of the navigation destination and the type of the geographical location of the navigation destination, based on the type of the geographical location, the first vehicle may present a long-shot image (the first image) at a lane end location used to identify the visual elements of the lane, or change the materials of the visual elements of the lane.

It can be understood that a length, a width, and a location of a display area of the first image are all changeable. This embodiment provides only several possible examples. The first image may be displayed next to a speed identifier, may be displayed by overlapping the speed identifier, may fully occupy an upper part of an entire display panel, or the like.

FIG. 8c is a schematic diagram of a self-driving interface according to an embodiment of this application. As shown in FIG. 8c, if the geographical location of the navigation destination of the first vehicle is located on a seaside, a first image (which may include, for example, a coconut tree and seawater) used to indicate the seaside may be displayed on the self-driving interface.

FIG. 8d is a schematic diagram of a self-driving interface according to an embodiment of this application. As shown in FIG. 8d, if the geographical location of the navigation destination of the first vehicle is located in a mountain area, a first image (which may include, for example, a mountain) used to indicate the mountain area may be displayed on the self-driving interface.

FIG. 8e is a schematic diagram of a self-driving interface according to an embodiment of this application. As shown in FIG. 8e, if the geographical location of the navigation destination of the first vehicle is located in a forest, a first image (which may include, for example, a plurality of trees) used to indicate the forest may be displayed on the self-driving interface.

The foregoing first images are merely examples, and do not constitute any limitation on this application.

In an embodiment, the first vehicle may further detect a third vehicle; obtain a geographical location of a navigation destination of the third vehicle; and display a second image based on the geographical location of the navigation destination of the third vehicle, where the second image is used to indicate a type of the geographical location of the navigation destination of the third vehicle.

In an embodiment of this application, if a driver of another vehicle (the third vehicle) is willing to disclose information about a destination (type) of the another vehicle, the type of a geographical location of the destination of the another vehicle may further be displayed on the self-driving interface.

FIG. 8f is a schematic diagram of a self-driving interface according to an embodiment of this application. As shown in FIG. 8f, the first vehicle (the largest vehicle in the figure) can learn, by using the self-driving interface, that a vehicle ahead and a left-hand vehicle rather than a right-hand vehicle are going to a same type of destination (forest) as the first vehicle, because the vehicle ahead and the left-hand vehicle are identified by a special color and/or texture or a second image (including trees) indicating types of geographical locations of navigation destinations of the third vehicles is displayed around these vehicles.

In an embodiment of this application, the first vehicle may obtain the geographical location of the navigation destination of the first vehicle, and display the first image based on the geographical location, where the first image is used to indicate the type of the geographical location of the navigation destination of the first vehicle. The first vehicle may display a corresponding image on the self-driving interface based on a geographical location of a navigation destination, to enrich content of the self-driving interface.

In an embodiment of this application, the first vehicle may display an intersection stop indication on the self-driving interface when traveling to an intersection stop area.

In an embodiment, the first vehicle may detect that the first vehicle travels to the intersection stop area and display the intersection stop indication 901. In an embodiment, the intersection stop area may be an area to which the first vehicle travels within a preset distance (for example, 20 m) from a red light intersection.

In an embodiment, the first vehicle may determine, based on an image or a video, that the first vehicle currently enters the intersection stop area, or may determine, based on the navigation information, that the first vehicle currently enters the intersection stop area.

In an embodiment, the first vehicle may obtain a status of a traffic light that is corresponding to the first vehicle and that is at a current intersection, and display a first intersection stop indication when the status of the traffic light is a red light or yellow light state.

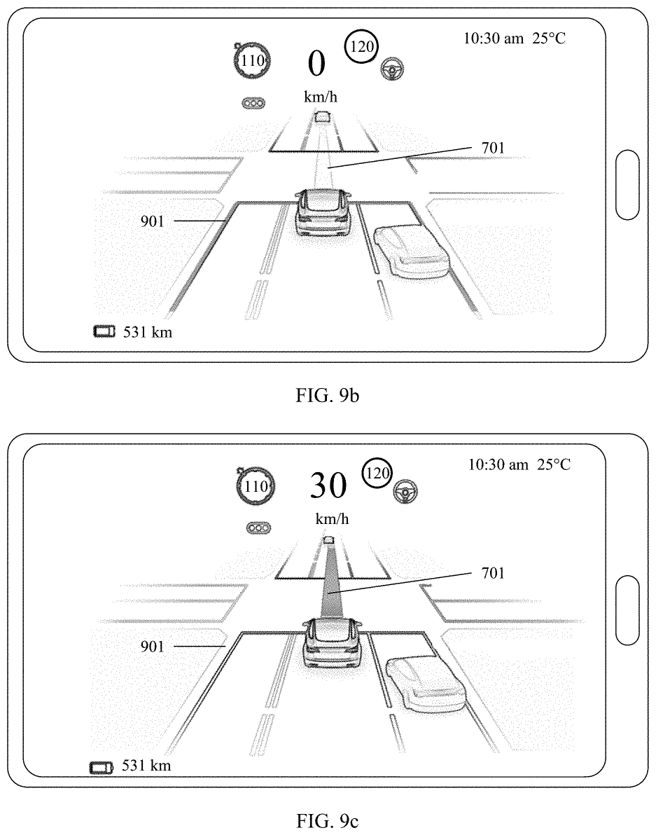

FIG. 9a is a schematic diagram of a self-driving interface according to an embodiment of this application. As shown in FIG. 9a, when the first vehicle travels to an intersection stop area, an intersection stopline is displayed on the self-driving interface.

It should be noted that, if the first vehicle is in a navigation state, a navigation indication 701 may further be displayed, and a part that is of the navigation indication 701 and that is beyond the intersection stopline is weakened for display. A weakening manner may be displaying only an outline of the navigation indication 701, increasing transparency of the navigation indication 701, or the like. This is not limited herein.

In an embodiment, the intersection stop indication includes the first intersection stop indication or a second intersection stop indication. The first vehicle may display the first intersection stop indication when detecting that a vehicle head of the first vehicle does not exceed the intersection stop area; and display the second intersection stop indication when detecting that the vehicle head of the first vehicle exceeds the intersection stop area, where the first intersection stop indication is different from the second intersection stop indication.

In an embodiment of this application, when the vehicle head of the first vehicle exceeds the intersection stop indication 901, display content of the first intersection stop indication 901 may be changed. For example, the intersection stop indication may be weakened for display. A weakening manner may be increasing transparency of the intersection stop indication or the like. This is not limited herein.

FIG. 9b is a schematic diagram of a self-driving interface according to an embodiment of this application. As shown in FIG. 9b, the first vehicle may detect that the first vehicle travels to an intersection stop area, and correspondingly an intersection stop indication and a weakened navigation indication 701 are displayed on the self-driving interface.

FIG. 9c is a schematic diagram of a self-driving interface according to an embodiment of this application. As shown in FIG. 9c, the first vehicle may detect that the first vehicle travels beyond an intersection stop area (the vehicle head of the first vehicle exceeds the intersection stop area), and correspondingly a weakened intersection stop indication and an enhanced navigation indication 701 (that is, displaying an outline of the complete navigation indication 701, changing a color, or reducing transparency of the navigation indication 701) are displayed on the self-driving interface.

In another embodiment, the intersection stop indication includes a third intersection stop indication or a fourth intersection stop indication. The first vehicle may display the third intersection stop indication when detecting that the first vehicle travels to the intersection stop area and that a traffic light corresponding to the intersection stop area is a red light or a yellow light; and display the fourth intersection stop indication when detecting that the first vehicle travels to the intersection stop area and that a traffic light corresponding to the intersection stop area is a green light, where the third intersection stop indication is different from the fourth intersection stop indication.

In an embodiment of this application, the first vehicle displays the intersection stop indication when traveling to the intersection stop area, and information about the traffic light at the current intersection is further considered. Specifically, the first vehicle displays the third intersection stop indication when the first vehicle travels to the intersection stop area and the traffic light corresponding to the intersection stop area is a red light or a yellow light; and displays the fourth intersection stop indication when the first vehicle travels to the intersection stop area and the traffic light corresponding to the intersection stop area is a green light. For example, the fourth intersection indication may be an enhanced third intersection indication (that is, changing a color or reducing transparency of the navigation indication 701).

In an embodiment of this application, the first vehicle may display a vehicle alarm prompt on the self-driving interface based on a distance between a nearby vehicle and the current vehicle.

In an embodiment, the first vehicle may detect a fourth vehicle; and display a vehicle alarm prompt when a distance between the fourth vehicle and the first vehicle is less than a preset distance.

In an embodiment, the vehicle alarm prompt includes a first vehicle alarm prompt or a second vehicle alarm prompt. The first vehicle may display the first vehicle alarm prompt when the distance between the fourth vehicle and the first vehicle is the first distance; and display the second vehicle alarm prompt when the distance between the fourth vehicle and the first vehicle is the second distance, where the first distance is different from the second distance, and the first vehicle alarm prompt is different from the second vehicle alarm prompt.

In an embodiment of this application, the first vehicle may obtain distances between other vehicles and the first vehicle by using the distance sensor carried by the first vehicle, and display the vehicle alarm prompt after detecting that the distance between a vehicle (the fourth vehicle) and the first vehicle is less than the preset distance.

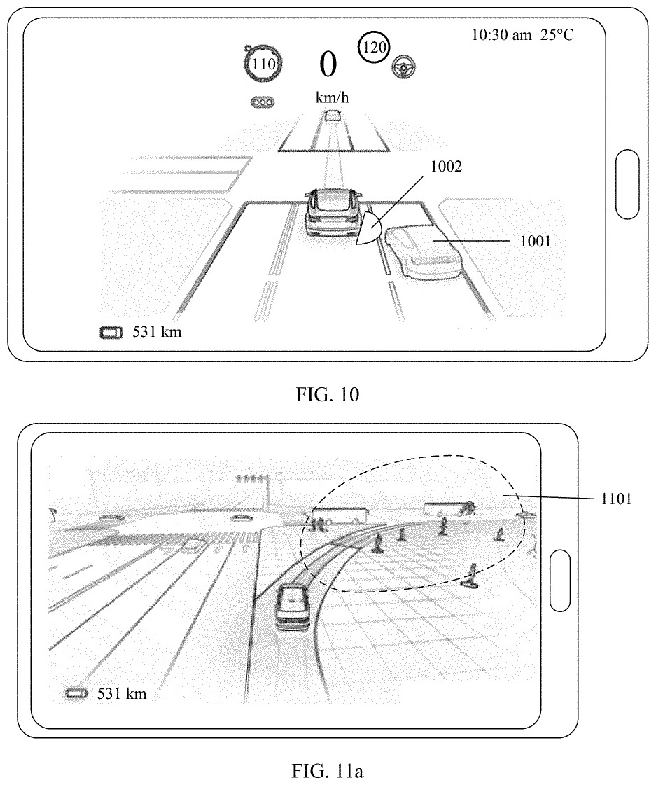

In an embodiment of this application, when another vehicle (the fourth vehicle) is around the first vehicle, an alarm alarm prompt (a danger prompt graphic) may be displayed on the self-driving interface by using a nearest point at which the current vehicle approaches the fourth vehicle as a center of a circle. FIG. 10 is a schematic diagram of a self-driving interface according to an embodiment of this application. As shown in FIG. 10, the first vehicle may detect a fourth vehicle 1001, and display a vehicle alarm prompt 1002 on the self-driving interface when a distance between the fourth vehicle 1001 and the first vehicle is less than the preset distance.

In an embodiment, colors of the alarm prompts may be different based on the distance between the fourth vehicle and the first vehicle. For example, the alarm prompt is displayed in red when the distance is particularly short, and is displayed in yellow when the distance is relatively short.

In an embodiment, when the distance between the fourth vehicle and the first vehicle continuously changes, the color of the danger prompt graphic may be changed gradually, instead of suddenly changing from red to yellow (or from yellow to red) when the corresponding threshold is exceeded.

In an embodiment of this application, the first vehicle may display a vehicle alarm prompt on the self-driving interface based on a distance between a nearby vehicle and the current vehicle, so that the driver can know a collision risk between the first vehicle and the another vehicle by using the alarm prompt displayed on the self-driving interface.

In an embodiment of this application, when the first vehicle changes from a turning state to a straight-driving state, or when the first vehicle changes from a straight-driving state to a turning state, the first vehicle may change a current display field of view of the self-driving interface.

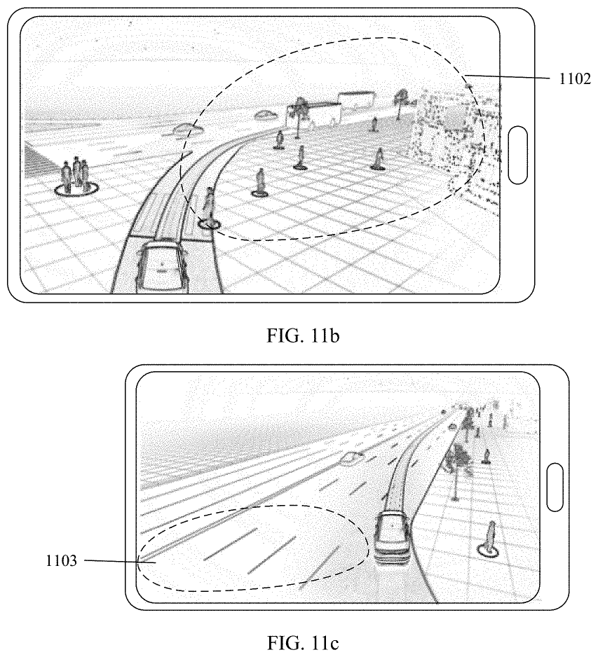

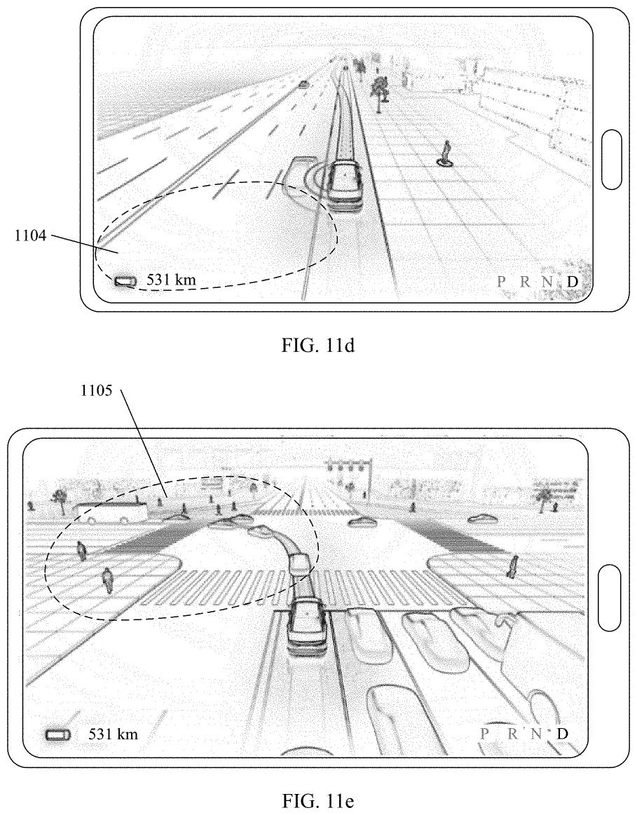

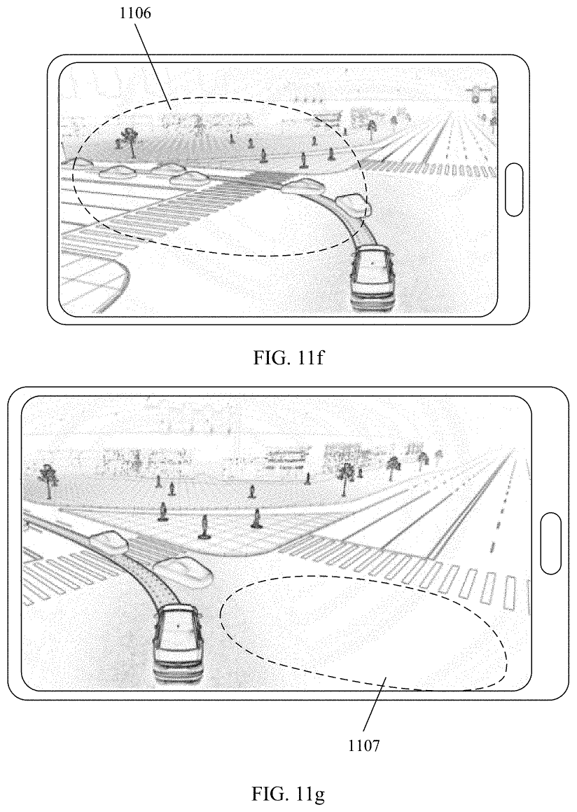

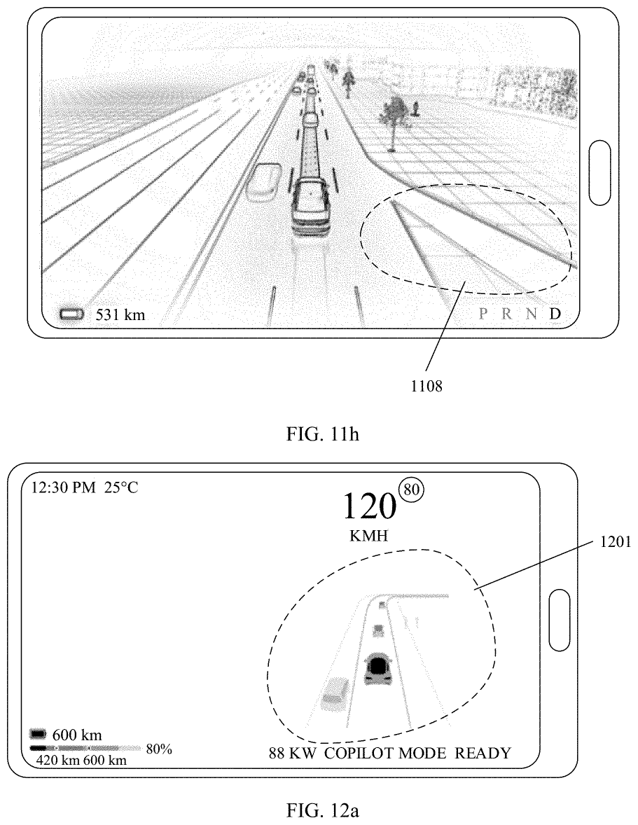

Specifically, FIG. 11a is a schematic diagram of a self-driving interface according to an embodiment of this application. As shown in FIG. 11a, the first vehicle may display a first area based on a straight-driving state of the first vehicle.

FIG. 11b is a schematic diagram of a self-driving interface according to an embodiment of this application. As shown in FIG. 11b, the first vehicle may display a second area based on a change of the first vehicle from the straight-driving state to a right-turning state, where a right-front scene area 1102 that is included in the second area and that is in a traveling direction of the first vehicle is greater than a right-front scene area 1101 included in the first area.

In this embodiment of this application, before turning right, the driver pays more attention to right-front information, to mainly determine whether there is a pedestrian. Therefore, the right-front scene area 1102 that is included in the second area and that is in the traveling direction of the first vehicle is greater than the right-front scene area 1101 included in the first area.

FIG. 11c is a schematic diagram of a self-driving interface according to an embodiment of this application. As shown in FIG. 11c, the first vehicle may display a third area based on a right-turning state of the first vehicle.

FIG. 11d is a schematic diagram of a self-driving interface according to an embodiment of this application. As shown in FIG. 11d, the first vehicle may display a fourth area based on a change of the first vehicle from the right-turning state to a straight-driving state, where a left-rear scene area 1103 that is included in the third area and that is in a traveling direction of the first vehicle is greater than a left-rear scene area 1104 included in the fourth area.

In an embodiment of this application, after turning left, the driver pays more attention to right-rear information, to mainly determine whether there is an incoming vehicle. Therefore, the right-rear scene area 1103 that is included in the third area and that is in the traveling direction of the first vehicle is greater than the right-rear scene area 1104 included in the fourth area.

FIG. 11e is a schematic diagram of a self-driving interface according to an embodiment of this application. As shown in FIG. 11e, the first vehicle may display a fifth area based on a straight-driving state of the first vehicle.

FIG. 11f is a schematic diagram of a self-driving interface according to an embodiment of this application. As shown in FIG. 11f, the first vehicle may display a sixth area based on a change of the first vehicle from the straight-driving state to a left-turning state, where a left-front scene area 1105 that is included in the fifth area and that is in a traveling direction of the first vehicle is greater than a left-front scene area 1106 included in the sixth area.

In an embodiment of this application, before turning left, the driver pays more attention to left-front information, to mainly determine whether there is a pedestrian. Therefore, the left-front scene area 1105 that is included in the fifth area and that is in the traveling direction of the first vehicle is greater than the left-front scene area 1106 included in the sixth area.

FIG. 11g is a schematic diagram of a self-driving interface according to an embodiment of this application. As shown in FIG. 11g, the first vehicle may display a seventh area based on a left-turning state of the first vehicle.

FIG. 11h is a schematic diagram of a self-driving interface according to an embodiment of this application. As shown in FIG. 11h, the first vehicle may display an eighth area based on a change of the first vehicle from the left-turning state to a straight-driving state, where a right-rear scene area 1107 that is included in the seventh area and that is in a traveling direction of the first vehicle is greater than a right-rear scene area 1108 included in the eighth area.

In an embodiment of this application, after turning left, the driver pays more attention to right-rear information, to mainly determine whether there is an incoming vehicle. Therefore, the right-rear scene area 1107 that is included in the seventh area and that is in the traveling direction of the first vehicle is greater than the right-rear scene area 1108 included in the eighth area.

It should be noted that the scene areas obtained through division in FIG. 11a to FIG. 11h are merely examples, and do not constitute any limitation on this application.

In other words, in this embodiment of this application, the first vehicle may change, based on an intersection turning area, a display field of view at which information is displayed on the display. Specifically, the turning area may be obtained by sensing whether a steering wheel rotates left or right. Alternatively, whether high-precision map navigation is enabled during vehicle traveling is determined and then whether the vehicle has traveled to an intersection requiring a left turn or a right turn is determined by using a navigation route. Alternatively, during vehicle traveling, only a high-precision map is enabled but no navigation is used, and the driver drives the vehicle instead; in this case, whether the vehicle needs to turn left or turn right is further determined by determining whether the vehicle travels at a preset distance close to an intersection and travels in a left-turn lane or a right-turn lane.

The field of view in this embodiment is a field of view at which information is displayed on the display. Specifically, a location of the current vehicle (e.g., the first vehicle) may be tracked by using a virtual camera, to present an object that can be seen in the field of view of the camera. Changing the display field of view means changing a location of the virtual camera relative to the current vehicle (x-axis, y-axis, and z-axis coordinates and angles in various directions), to present, on the display, a change of the object that can be seen in the field of view of the virtual camera.

For example, the current vehicle is used as an origin of coordinates, a direction facing a front side of the vehicle is a positive direction of a y-axis, and the traveling direction of the vehicle is a negative direction of the y-axis; and facing the vehicle, a right-hand side of the vehicle is a positive direction of an x-axis, and a left-hand side of the vehicle is a negative direction of the x-axis. The location of the virtual camera is above a z-axis, and is in a positive direction of the z-axis and in the positive direction of the y-axis. A field of view in this default state is referred to as a default field of view (referred to as a “default forward field of view” in the following embodiment).

It can be understood that a location of the origin and directions of various axes can be customized by a developer.

Turning right is used as an example. Before turning right, the driver pays more attention to right-front information, to mainly determine whether there is a pedestrian; and after the turning, the driver pays more attention to left-rear information, to mainly determine whether there is an incoming vehicle. If it is determined that the driver is about to turn right, the field of view of the virtual camera is changed from the default forward field of view to look right first (e.g., the virtual camera rotates right, and rotates from a direction facing the negative direction of the y-axis to the negative direction of the x-axis), and then the field of view of the virtual camera is changed to look left (e.g., the virtual camera rotates left, and rotates to the positive direction of the x-axis). After the turning ends and straight driving starts, the default forward field of view is restored (as shown in FIG. 11d, the virtual camera faces the negative direction of the y-axis).

In an embodiment of this application, when the first vehicle changes from a turning state to a straight-driving state, or when the first vehicle changes from a straight-driving state to a turning state, the first vehicle may change a current display field of view, so that the driver can know information about an area that may have a safety risk when the vehicle turns. This improves driving safety.

In this embodiment of this application, the first vehicle may change the current display field of view of the self-driving interface based on a change of a traveling speed.

In an embodiment, the first vehicle may display a ninth area based on a first traveling speed of the first vehicle, and display a tenth area based on a second traveling speed of the first vehicle, where the ninth area and the tenth area are scene areas in which a traveling location of the first vehicle is located, the second traveling speed is higher than the first traveling speed, and a scene area included in the ninth area is greater than a scene area included in the tenth area.

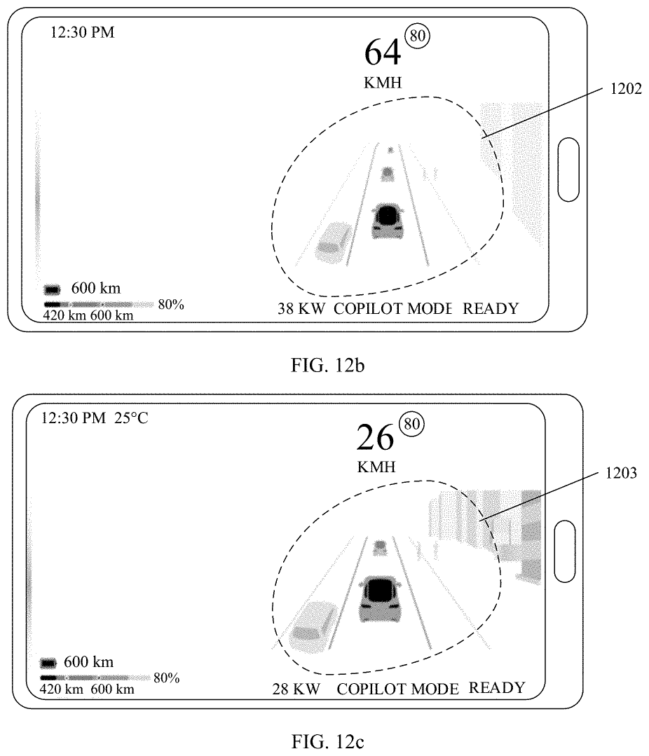

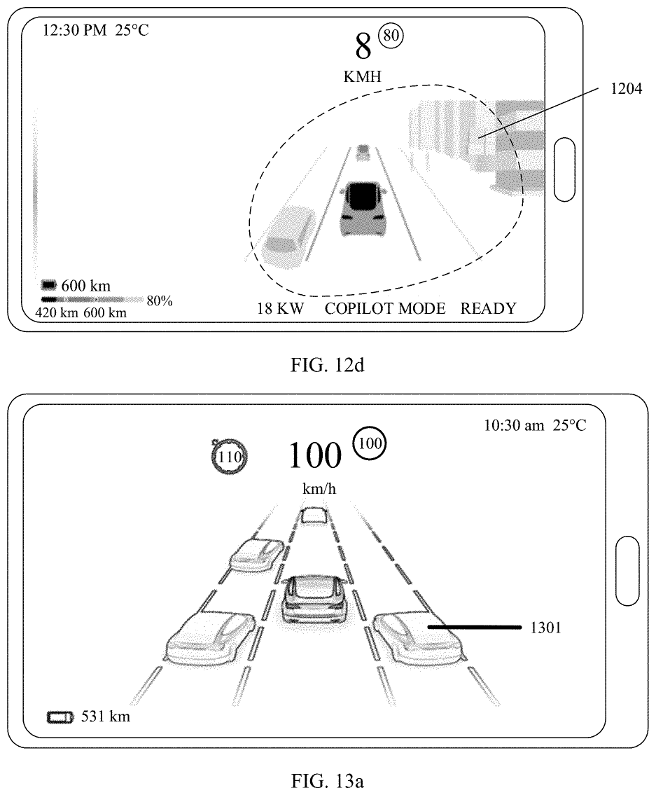

FIG. 12a to FIG. 12d are schematic diagrams of a self-driving interface according to an embodiment of this application. As shown in FIG. 12a to FIG. 12d, a case in which a vehicle speed is increasingly low is described from FIG. 12a to FIG. 12d. It can be learned that as the traveling speed of the first vehicle decreases, a scene area in which the traveling location of the first vehicle is located becomes smaller on the self-driving interface.

In an embodiment of this application, the first vehicle may make a road field of view displayed on the self-driving interface larger when the traveling speed of the vehicle increases, and correspondingly a road display range is larger. As the traveling speed of the vehicle decreases, more road information (buildings on both sides of a lane, pedestrians, roadside traffic facilities, and the like) displayed on a display panel becomes more obvious, and a road field of view displayed on the display panel becomes smaller, leading to a smaller road display range (the scene area in which the traveling location of the first vehicle is located).

For details about how to obtain through transformation the road field of view displayed on the self-driving interface, refer to the descriptions in the foregoing embodiment. Details are not described herein again.

As shown in FIG. 12a to FIG. 12d, from the case in which the vehicle speed is increasingly low, as described from FIG. 12a to FIG. 12d, it can be learned that the field of view is increasingly small. The field of view is large when the first vehicle travels at a high speed (a z-axis value of the location of the virtual camera is large), and the field of view is small when the first vehicle travels at a low speed (a z-axis value of the location of the virtual camera is small). It should be noted that the speed values in FIG. 12a to FIG. 12d are merely examples, and do not constitute any limitation on this application.

In addition, when the vehicle speed is relatively low, for example, when the vehicle travels in a street, the driver pays more attention to information about the surroundings of the vehicle, such as details of collision information. In this case, the field of view is closer to the vehicle, so that the driver focuses on information as the driver wants. As more road information (e.g., buildings on both sides of a lane, pedestrians, roadside traffic facilities, and the like) displayed on the display panel becomes more obvious, the road field of view displayed on the self-driving interface becomes smaller, leading to a smaller road display range. As shown in FIG. 12a to FIG. 12d, the traveling speed of the first vehicle is higher in FIG. 12a, and then buildings on a roadside are weakened for display (e.g., through color lightening, transparency increase, and/or the like), while the traveling speed of the first vehicle is lower in FIG. 12d, and then buildings on a roadside are enhanced for display (through color deepening, transparency decrease, and/or the like).

In an embodiment of this application, the first vehicle may display the ninth area based on the first traveling speed of the first vehicle, and display the tenth area based on the second traveling speed of the first vehicle, where the ninth area and the tenth area are the scene areas in which the traveling location of the first vehicle is located, the second traveling speed is higher than the first traveling speed, and the scene area included in the ninth area is greater than the scene area included in the tenth area. In the foregoing manner, when the traveling speed of the first vehicle is relatively high, a larger scene area may be displayed, so that the driver can know more road surface information when the traveling speed is relatively high. This improves driving safety.

In an embodiment of this application, the first vehicle may display, on the self-driving interface, a prompt indicating that a vehicle beside the first vehicle is inserted into the current traveling lane.

In an embodiment, the first vehicle may detect a fifth vehicle; display, when the fifth vehicle is located on a lane line of a lane in front of the traveling direction of the first vehicle, a third image corresponding to the fifth vehicle; and display, when the fifth vehicle travels to the lane in front of the traveling direction of the first vehicle, a fourth image corresponding to the fifth vehicle, where the third image is different from the fourth image.

In an embodiment of this application, when detecting that a vehicle (the fifth vehicle) is located on the lane line of the lane in front of the traveling direction of the first vehicle, the first vehicle determines that the fifth vehicle will overtake the first vehicle.

In an embodiment, the first vehicle may further determine, when the fifth vehicle is located on the lane line of the lane in front of the traveling direction of the first vehicle and a distance between the fifth vehicle and the first vehicle is less than a preset value, that the fifth vehicle will overtake the first vehicle.

In an embodiment, the first vehicle may process a photographed image or video, to determine that the fifth vehicle is located on the lane line of the lane in front of the traveling direction of the first vehicle. The first vehicle may send the photographed image or video to the server, so that the server determines that the fifth vehicle is located on the lane line of the lane in front of the traveling direction of the first vehicle, and then the first vehicle receives a determining result sent by the server.

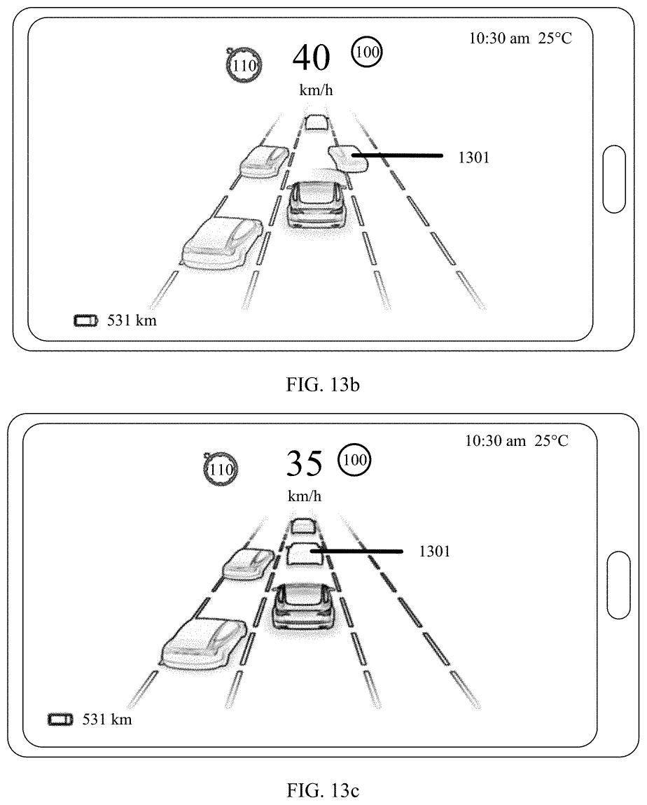

In an embodiment of this application, for example, the fifth vehicle may be located behind the first vehicle (as shown in FIG. 13a). If detecting that the fifth vehicle is carrying out an overtake action, the first vehicle may display, on the self-driving interface by using a special color identifier (such as white), an image corresponding to the fifth vehicle (for a fifth vehicle 1301 shown in FIG. 13b, in this case, the fifth vehicle 1301 is located on the lane line of the lane in front of the traveling direction of the first vehicle), indicating that the fifth vehicle hinders the speed of the first vehicle.

In an embodiment of this application, after detecting that the fifth vehicle completes overtaking, the first vehicle may change display content of the fifth vehicle. Specifically, the first vehicle may display, when the fifth vehicle travels to the lane in front of the traveling direction of the first vehicle (for a fifth vehicle 1301 shown in FIG. 13c, in this case, the fifth vehicle 1301 is located on the lane in front of the traveling direction of the first vehicle, but is not located on the lane line), a fourth image corresponding to the fifth vehicle. A color and/or transparency of the fourth image may be different from that of the third image.

It should be noted that, the third image in FIG. 13b and the fourth image in FIG. 13c are merely examples. Display content of the third image and the fourth image is not limited in this application, provided that vehicles presented during overtaking and overtaking completion may be distinguished between each other.

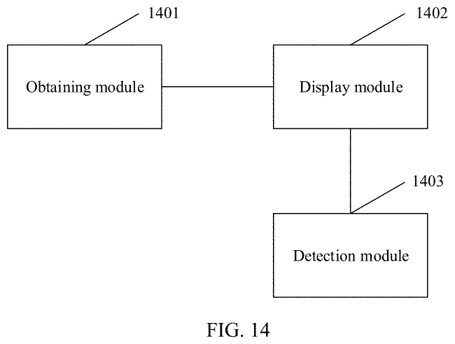

The following describes a vehicle-mounted device information display apparatus provided in an embodiment of this application. FIG. 14 is a schematic diagram of a structure of a vehicle-mounted device information display apparatus according to an embodiment of this application. As shown in FIG. 14, the information display apparatus includes:

an obtaining module 1401, configured to obtain information about lane lines of a road surface on which a first vehicle is located, where the lane lines are at least two lines on the road surface that are used to divide different lanes; and

a display module 1402, configured to display, based on the information about the lane lines, virtual lane lines whose types are consistent with those of the lane lines.

In an embodiment, the obtaining information about lane lines of a road surface on which a first vehicle is located includes:

obtaining information about lane lines of a lane in which the first vehicle is located.

In an embodiment, the lane lines include at least one of the following lane lines: a dashed line, a solid line, a double dashed line, a double solid line, and a dashed solid line.

In an embodiment, the lane lines include at least one of the following lane lines: a dashed white line, a solid white line, a dashed yellow line, a solid yellow line, a double dashed white line, a double solid yellow line, a dashed solid yellow line, and a double solid white line.

In an embodiment, the obtaining module 1401 is further configured to obtain information about a non-motor vehicle object on the road surface; and

the display module 1402 is further configured to display an identifier corresponding to the non-motor vehicle object.

In an embodiment, the apparatus further includes:

a receiving module, configured to receive a sharing instruction, where the sharing instruction carries an address of a second vehicle; and

a sending module, configured to send second shared information to the second vehicle in response to the sharing instruction, where the second shared information includes location information of the non-motor vehicle object.

In an embodiment, the receiving module is further configured to receive first shared information sent by a server or the second vehicle, where the first shared information includes the location information of the non-motor vehicle object; and

the display module 1402 is further configured to display an obstacle prompt on a navigation interface when the first vehicle enables navigation, where the obstacle prompt is used to indicate the non-motor vehicle object at a location corresponding to the location information.

In an embodiment, the non-motor vehicle object includes at least a road depression, an obstacle, and a road water accumulation.

In an embodiment, the display module 1402 is further configured to display a lane change indication when the non-motor vehicle object is located on a navigation path indicated by a navigation indication, where the navigation indication is used to indicate the navigation path of the first vehicle, and the lane change indication is used to instruct the first vehicle to avoid a traveling path of the non-motor vehicle object.

In an embodiment, the display module 1402 is further configured to: display a first alarm prompt when a distance between the first vehicle and the non-motor vehicle object is a first distance; and

display a second alarm prompt when the distance between the first vehicle and the non-motor vehicle object is a second distance, where the second alarm prompt is different from the first alarm prompt.

In an embodiment, a color or transparency of the first alarm prompt is different from that of the second alarm prompt.

In an embodiment, the obtaining module 1401 is further configured to obtain navigation information of the first vehicle; and

the display module 1402 is further configured to display the navigation indication based on the navigation information, where the navigation indication is used to indicate the navigation path of the first vehicle.

In an embodiment, the navigation indication includes a first navigation indication or a second navigation indication, and the display module 1402 is configured to: display the first navigation indication based on a stationary state of the first vehicle; and

display the second navigation indication based on a traveling state of the first vehicle, where the first navigation indication is different from the second navigation indication.

In an embodiment, a display color or display transparency of the first navigation indication is different from that of the second navigation indication.

In an embodiment, the navigation indication includes a third navigation indication or a fourth navigation indication, and the display module 1402 is configured to: display the third navigation indication based on a first environment of the first vehicle; and

display the fourth navigation indication based on a second environment of the first vehicle, where the first environment is different from the second environment, and the third navigation indication is different from the fourth navigation indication.

In an embodiment, the first environment includes at least one of the following environments: a weather environment in which the first vehicle is situated, a road surface environment in which the first vehicle is situated, a weather environment of a navigation destination of the first vehicle, a road surface environment of the navigation destination of the first vehicle, a traffic congestion environment of a road on which the first vehicle is located, a traffic congestion environment of the navigation destination of the first vehicle, or a brightness environment in which the first vehicle is situated.

In an embodiment, the display module 1402 is further configured to: display a first area based on a straight-driving state of the first vehicle; and

display a second area based on a change of the first vehicle from the straight-driving state to a left-turning state, where a left-front scene area that is included in the second area and that is in a traveling direction of the first vehicle is greater than a left-front scene area included in the first area; or

display a third area based on a left-turning state of the first vehicle; and

display a fourth area based on a change of the first vehicle from the left-turning state to a straight-driving state, where a right-rear scene area that is included in the third area and that is in a traveling direction of the first vehicle is greater than a right-rear scene area included in the fourth area; or

display a fifth area based on a straight-driving state of the first vehicle; and

display a sixth area based on a change of the first vehicle from the straight-driving state to a right-turning state, where a right-front scene area that is included in the fifth area and that is in a traveling direction of the first vehicle is less than a right-front scene area included in the sixth area; or

display a seventh area based on a right-turning state of the first vehicle; and

display an eighth area based on a change of the first vehicle from the right-turning state to a straight-driving state, where a left-rear scene area that is included in the seventh area and that is in a traveling direction of the first vehicle is greater than a left-rear scene area included in the eighth area.

In an embodiment, the display module 1402 is further configured to: display a ninth area based on a first traveling speed of the first vehicle; and

display a tenth area based on a second traveling speed of the first vehicle, where the ninth area and the tenth area are scene areas in which a traveling location of the first vehicle is located, the second traveling speed is higher than the first traveling speed, and a scene area included in the ninth area is greater than a scene area included in the tenth area.

In an embodiment, the obtaining module 1401 is further configured to obtain a geographical location of the navigation destination of the first vehicle; and

the display module 1402 is further configured to display a first image based on the geographical location, where the first image is used to indicate a type of the geographical location of the navigation destination of the first vehicle.

In an embodiment, a detection module 1403 is configured to detect a third vehicle;

the obtaining module 1401 is further configured to obtain a geographical location of a navigation destination of the third vehicle; and

the display module 1402 is further configured to display a second image based on the geographical location of the navigation destination of the third vehicle, where the second image is used to indicate a type of the geographical location of the navigation destination of the third vehicle.

In an embodiment, the type of the geographical location includes at least one of the following: city, mountain area, plain, forest, or seaside.

In an embodiment, the detection module 1403 is further configured to detect that the first vehicle travels to an intersection stop area, and the display module 1402 is further configured to display a first intersection stop indication.

In an embodiment, the intersection stop indication includes a first intersection stop indication or a second intersection stop indication, and the display module 1402 is further configured to:

display the first intersection stop indication when the detection module 1403 detects that a vehicle head of the first vehicle does not exceed the intersection stop area; and

display the second intersection stop indication when the detection module 1403 detects that the vehicle head of the first vehicle exceeds the intersection stop area, where the first intersection stop indication is different from the second intersection stop indication.

In an embodiment, the intersection stop indication includes a third intersection stop indication or a fourth intersection stop indication, and the display module 1402 is further configured to:

display the third intersection stop indication when the detection module 1403 detects that the first vehicle travels to the intersection stop area and that a traffic light corresponding to the intersection stop area is a red light or a yellow light; and

display the fourth intersection stop indication when the detection module 1403 detects that the first vehicle travels to the intersection stop area and that a traffic light corresponding to the intersection stop area is a green light, where the third intersection stop indication is different from the fourth intersection stop indication.

In an embodiment, the detection module 1403 is further configured to detect a fourth vehicle; and

the display module 1402 is further configured to display a vehicle alarm prompt when a distance between the fourth vehicle and the first vehicle is less than a preset distance.

In an embodiment, the vehicle alarm prompt includes a first vehicle alarm prompt or a second vehicle alarm prompt, and the display module 1402 is further configured to: display the first vehicle alarm prompt when the distance between the fourth vehicle and the first vehicle is the first distance; and

display the second vehicle alarm prompt when the distance between the fourth vehicle and the first vehicle is the second distance, where the first distance is different from the second distance, and the first vehicle alarm prompt is different from the second vehicle alarm prompt.

In an embodiment, the detection module 1403 is further configured to detect a fifth vehicle; and

the display module 1402 is further configured to: display, when the fifth vehicle is located on a lane line of a lane in front of the traveling direction of the first vehicle, a third image corresponding to the fifth vehicle; and

display, when the fifth vehicle travels to the lane in front of the traveling direction of the first vehicle, a fourth image corresponding to the fifth vehicle, where the third image is different from the fourth image.

This application further provides a vehicle, including a processor, a memory, and a display. The processor is configured to obtain and execute code in the memory to perform the vehicle-mounted device information display method according to the foregoing embodiments.

In an embodiment, the vehicle may be an intelligent vehicle that supports a self-driving function.

In addition, it should be noted that the described apparatus embodiments are merely examples. The units described as separate parts may or may not be physically separate, and parts displayed as units may or may not be physical units, and may be located in one position, or may be distributed on a plurality of network units. Some or all of the modules may be selected based on an actual requirement to achieve the objectives of the solutions of the embodiments. In addition, in the accompanying drawings of the apparatus embodiments provided in this application, connection relationships between modules indicate that the modules have communication connections to each other, which may be implemented as one or more communication buses or signal cables.

Based on the description of the foregoing implementations, a person skilled in the art may clearly understand that this application may be implemented by software in addition to necessary universal hardware, or certainly may be implemented by dedicated hardware, including an application-specific integrated circuit, a dedicated CPU, a dedicated memory, a dedicated component, and the like. Usually, all functions completed by a computer program may be easily implemented by using corresponding hardware, and a specific hardware structure used to implement a same function may also be of various forms, for example, a form of an analog circuit, a digital circuit, or a dedicated circuit. However, in this application, a software program implementation is a better implementation in most cases. Based on such an understanding, the technical solutions of this application essentially or the part contributing to a conventional technology may be implemented in a form of a software product. The computer software product is stored in a readable storage medium, such as a floppy disk, a USB drive, a removable hard disk, a ROM, a RAM, a magnetic disk, or an optical disc of a computer, and includes several instructions for instructing a computer device (which may be a personal computer, a training device, or a network device) to perform the methods described in the embodiments of this application.

All or some of the foregoing embodiments may be implemented by using software, hardware, firmware, or any combination thereof. When the software is used to implement the embodiments, all or some of the embodiments may be implemented in a form of a computer program product.

The computer program product includes one or more computer instructions. When the computer program instructions are loaded and executed on a computer, all or some of the procedures or functions according to the embodiments of this application are generated. The computer may be a general purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, training device, or data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk (SSD)), or the like.

1. A vehicle method, comprising:
obtaining information about lane lines of a road surface on which a first vehicle is located, wherein the lane lines include at least two lines on the road surface that are used to divide different lanes; and
displaying, based on the information about the lane lines, virtual lane lines whose types are consistent with those of the lane lines, wherein the lane lines comprise at least one of following lane lines: a dashed line, a solid line, a double dashed line, a double solid line, or a dashed solid line.

2. The method according to claim 1, wherein the obtaining information about lane lines of a road surface on which a first vehicle is located comprises:
obtaining information about lane lines of a lane in which the first vehicle is located.

3. The method according to claim 1, further comprising:
obtaining information about a non-motor vehicle object on the road surface; and
displaying, based on the information about the non-motor vehicle object, an identifier corresponding to the non-motor vehicle object.

4. The method according to claim 3, further comprising:
receiving a sharing instruction that carries an address of a second vehicle; and
sending second shared information to the second vehicle in response to the sharing instruction, wherein the second shared information comprises location information of the non-motor vehicle object.

5. The method according to claim 4, further comprising:
receiving first shared information sent by a server or the second vehicle, wherein the first shared information comprises the location information of the non-motor vehicle object; and
displaying an obstacle prompt on a navigation interface when the first vehicle enables navigation, wherein the obstacle prompt is used to indicate the non-motor vehicle object at a location corresponding to the location information; wherein the non-motor vehicle object comprises at least a road depression, an obstacle, and a road water accumulation.

6. The method according to claim 3, further comprising:
displaying a lane change indication when the non-motor vehicle object is located on a navigation path indicated by a navigation indication, wherein the navigation indication is used to indicate the navigation path of the first vehicle, and the lane change indication is used to instruct the first vehicle to avoid a traveling path of the non-motor vehicle object.

7. The method according to claim 3, further comprising:
displaying a first alarm prompt when a distance between the first vehicle and the non-motor vehicle object is a first distance; and
displaying a second alarm prompt when the distance between the first vehicle and the non-motor vehicle object is a second distance, wherein the second alarm prompt is different from the first alarm prompt; wherein a color or transparency of the first alarm prompt is different from that of the second alarm prompt.

8. The method according to claim 1, further comprising:
obtaining navigation information of the first vehicle; and
displaying a navigation indication based on the navigation information, wherein the navigation indication is used to indicate a navigation path of the first vehicle; wherein the navigation indication comprises a first navigation indication or a second navigation indication, and the displaying the navigation indication based on the navigation information comprises:
displaying the first navigation indication based on a stationary state of the first vehicle; and
displaying the second navigation indication based on a traveling state of the first vehicle, wherein the first navigation indication is different from the second navigation indication, wherein a display color or display transparency of the first navigation indication is different from that of the second navigation indication.

9. The method according to claim 8, wherein the navigation indication further comprises a third navigation indication or a fourth navigation indication, and the displaying the navigation indication based on the navigation information comprises:
displaying the third navigation indication based on a first environment of the first vehicle; and
displaying the fourth navigation indication based on a second environment of the first vehicle, wherein the first environment is different from the second environment, and the third navigation indication is different from the fourth navigation indication,
wherein the first environment comprises at least one of the following environments: a weather environment in which the first vehicle is situated, a road surface environment in which the first vehicle is situated, a weather environment of a navigation destination of the first vehicle, a road surface environment of the navigation destination of the first vehicle, a traffic congestion environment of a road on which the first vehicle is located, a traffic congestion environment of the navigation destination of the first vehicle, or a brightness environment in which the first vehicle is situated.

10. The method according to claim 1, further comprising:
displaying a first area based on a straight-driving state of the first vehicle; and
displaying a second area based on a change of the first vehicle from the straight-driving state to a right-turning state, wherein a right-front scene area that is comprised in the second area and that is in a traveling direction of the first vehicle is greater than a right-front scene area comprised in the first area; or
displaying a third area based on a right-turning state of the first vehicle; and
displaying a fourth area based on a change of the first vehicle from the right-turning state to a straight-driving state, wherein a left-rear scene area that is comprised in the third area and that is in a traveling direction of the first vehicle is greater than a left-rear scene area comprised in the fourth area; or
displaying a fifth area based on a straight-driving state of the first vehicle; and
displaying a sixth area based on a change of the first vehicle from the straight-driving state to a left-turning state, wherein a left-front scene area that is comprised in the fifth area and that is in a traveling direction of the first vehicle is less than a left-front scene area comprised in the sixth area; or
displaying a seventh area based on a left-turning state of the first vehicle; and
displaying an eighth area based on a change of the first vehicle from the left-turning state to a straight-driving state, wherein a right-rear scene area that is comprised in the seventh area and that is in a traveling direction of the first vehicle is greater than a right-rear scene area comprised in the eighth area.

11. The method according to claim 1, further comprising:
displaying a ninth area based on a first traveling speed of the first vehicle; and
displaying a tenth area based on a second traveling speed of the first vehicle, wherein the ninth area and the tenth area are scene areas in which a traveling location of the first vehicle is located, the second traveling speed is higher than the first traveling speed, and a scene area comprised in the ninth area is greater than a scene area comprised in the tenth area.

12. The method according to claim 1, further comprising:
obtaining a geographical location of a navigation destination of the first vehicle; and
displaying a first image based on the geographical location, wherein the first image is used to indicate a type of the geographical location of the navigation destination of the first vehicle.

13. The method according to claim 1, further comprising:
detecting a third vehicle;
obtaining a geographical location of a navigation destination of the third vehicle; and
displaying a second image based on the geographical location of the navigation destination of the third vehicle, wherein the second image is used to indicate a type of the geographical location of the navigation destination of the third vehicle; wherein the type of the geographical location comprises at least one of the following: city, mountain area, plain, forest, or seaside.

14. The method according to claim 1, further comprising:
detecting that the first vehicle travels to an intersection stop area and displaying an intersection stop indication.

15. The method according to claim 14, wherein the intersection stop indication comprises a first intersection stop indication or a second intersection stop indication, and the detecting that the first vehicle travels to an intersection stop area and displaying an intersection stop indication comprises:
displaying the first intersection stop indication when detecting that a vehicle head of the first vehicle does not exceed the intersection stop area; and
displaying the second intersection stop indication when detecting that the vehicle head of the first vehicle exceeds the intersection stop area, wherein the first intersection stop indication is different from the second intersection stop indication.

16. The method according to claim 14, wherein the intersection stop indication comprises a third intersection stop indication or a fourth intersection stop indication, and the detecting that the first vehicle travels to an intersection stop area and displaying an intersection stop indication comprises:
displaying the third intersection stop indication when detecting that the first vehicle travels to the intersection stop area and that a traffic light corresponding to the intersection stop area is a red light or a yellow light; and
displaying the fourth intersection stop indication when detecting that the first vehicle travels to the intersection stop area and that a traffic light corresponding to the intersection stop area is a green light, wherein the third intersection stop indication is different from the fourth intersection stop indication.

17. The method according to claim 1, further comprising:
detecting a fourth vehicle; and
displaying a vehicle alarm prompt when a distance between the fourth vehicle and the first vehicle is less than a preset distance.

18. The method according to claim 17, wherein the vehicle alarm prompt comprises a first vehicle alarm prompt or a second vehicle alarm prompt, and the displaying a vehicle alarm prompt when a distance between the fourth vehicle and the first vehicle is less than a preset distance comprises:
displaying the first vehicle alarm prompt when the distance between the fourth vehicle and the first vehicle reaches a first distance; and
displaying the second vehicle alarm prompt when the distance between the fourth vehicle and the first vehicle reaches a second distance, wherein the first distance is different from the second distance, and the first vehicle alarm prompt is different from the second vehicle alarm prompt.

19. The method according to claim 1, further comprising:
detecting a fifth vehicle;
displaying a third image corresponding to the fifth vehicle, when the fifth vehicle is located on a lane line of a lane in front of a traveling direction of the first vehicle; and
displaying a fourth image corresponding to the fifth vehicle, when the fifth vehicle travels to the lane in front of the traveling direction of the first vehicle, wherein the third image is different from the fourth image.

20. A vehicle, comprising:
a display;
a processor; and
a memory to store instructions, which when executed by the processor, cause the processor to perform operations, the operations comprising:
obtaining information about lane lines of a road surface on which a first vehicle is located, wherein the lane lines include at least two lines on the road surface that are used to divide different lanes, and
displaying, based on the information about the lane lines, virtual lane lines whose types are consistent with those of the lane lines, wherein the lane lines comprise at least one of following lane lines: a dashed line, a solid line, a double dashed line, a double solid line, or a dashed solid line.
